(19) United States
(12) Patent Application Publication
(10) Pub. No.: US 2012/0280419 A1
(43) Pub. Date: Nov. 8, 2012

(54) METHOD AND APPARATUS FOR FLUIDIC PELLETIZATION, TRANSPORT, AND PROCESSING OF MATERIALS

(75) Inventors: J. WAYNE MARTIN, Buchanan, VA (US); Roger Blake Wright, Staunton, VA (US)

(73) Assignee: GALA INDUSTRIES, INC., Eagle Rock, VA (US)

(21) Appl. No.: 13/463,651

(22) Filed: May 3, 2012

Related U.S. Application Data
(60) Provisional application No. 61/482,076, filed on May 3, 2011.

(51) Int. Cl. B29B 9/16; D01D 5/40

(52) U.S. Cl. 264/140; 425/6

(57) ABSTRACT

A continuous process wherein a material is melt processed and subsequently pelletized, transported, optionally chemically and/or physically modified, and subsequently optionally defluidized utilizing fluidic processing. The transport fluids and fluid combinations utilize a wide range of process temperatures facilitating enhancement of conditioning, improvement of moisture content, pelletization of hygroscopic, water-sensitive, and water-soluble materials, pelletization of non-polymeric and rheologically non-shear sensitive and marginally shear-sensitive polymeric materials, modification of pellet components through extraction, pelletization of low melting materials, tacky materials, pellet coating, and pellet impregnation otherwise difficult and challenging using conventional technologies.

### CROSS-REFERENCE TO RELATED APPLICATION

This application claim priority under 35 U.S.C. §119 to U.S. Provisional Application 61/482,076, filed 3 May 2011, which is hereby incorporated by reference in its entirety as if fully set forth herein.

### BACKGROUND OF THE INVENTION

1. Field of Invention

The present invention relates generally to a method such that a material is melt processed and subsequently pelletized, transported, optionally chemically and/or physically modified, and subsequently optionally dried utilizing fluidic processing. The choice and use of fluids and fluid combinations can facilitate a wider range of process temperatures, enhancement of conditioning, improvement of moisture content, pelletization of hygroscopic, water-sensitive, and water-soluble materials, pelletization of non-polymeric and rheologically non-shear sensitive and marginally shear-sensitive polymeric materials, modification of pellet components through extraction, pelletization of low melting materials, tacky materials, pellet coating, and pellet impregnation otherwise difficult and challenging using conventional technologies.

2. Description of Related Art

The generally independent processes and equipment for melt processing, pelletization, facilitation of pellet transport, defluidizing, conditioning, and post processing manipulations are known, some for many years, and used in many applications. The limited use of solvents in combination with conventional pelletization processes to increase temperature of the process water is also known. The application of the processes subsequent to melt processing utilizing fluids and fluid combinations and multiple process sequences utilizing those fluids, alone or in combination, to facilitate a wider range of process temperatures, enhancement of conditioning including slow conditioning, improvement of final product moisture content, pelletization of hygroscopic as well as water-sensitive and water-soluble materials, pelletization of non-polymeric and rheologically non-shear sensitive and marginally shear-sensitive polymeric materials, reduction of pellet component loss through extraction, and alternative coating and pellet impregnation capabilities otherwise difficult and challenging using conventional technologies generally remain silent in the prior art.

World Patent Application Publication No. WO2007/064580, owned by the assignee of the current invention, discloses the controlled cooling of melt processed materials with narrow or low melting ranges, high melt flow formulations, including polymeric mixtures, formulations, dispersions, and solutions. Waxes, asphalt, adhesives and gum base formulations are disclosed. The document does not disclose pelletization and subsequent processing using fluids other than water and is similarly silent regarding non-polymeric and minimally shear-sensitive materials. Similarly, post-processing fluid manipulations of the pellets produced are not disclosed.

Controlled cooling of melt processed materials with hot-face pelletization of waxes and wax-like polymers, organic and cyclic polymers and oligomers, high melt flow materials, and organic compounds is disclosed in World Patent Application Publication No. WO2007/103509 owned by the assignee of the current invention. The document remains silent as to the use of fluids in pelletization and subsequent processing.

Similarly, pelletization equipment and its use following extrusion processing have been implemented for many years by the assignee as demonstrated in prior art disclosures including U.S. Pat. Nos. 4,123,207; 4,251,198; 4,500,271; 4,621,996; 4,728,176; 4,888,990; 5,059,103; 5,403,176; 5,624,688; 6,332,765; 6,551,087; 6,793,473; 6,824,371; 6,925,741; 7,033,152; 7,172,397; 7,267,540; 7,318,719; US Patent Application Publication No. 20060165834; German Patents and Applications including DE 32 43 332, DE 37 02 841, DE 87 01 490, DE 196 42 389, DE 196 51 354, DE 296 24 638; World Patent Application Publications WO2006/081140, WO2006/087179, WO2007/027877, and WO2007/089497; and European Patents including EP 1 218 156 and EP 1 582 327. These patents and applications are all owned by the assignee and are included herein by way of reference in their entirety.

Formulations containing flavors and/or fragrances dispersed or dissolved in a matrix material such as polysaccharides, carbohydrates, agar, and at least partially hydrolyzed polyvinyl acetate, for example, have been extruded through a die and optionally pelletized, or microencapsulated, with immediate low temperature quenching as demonstrated in prior art disclosures exemplary of which are European Patent No. EP 1 627 573; US Patent Application Publication No. 20070128234; U.S. Pat. Nos. 3,704,137; 4,610,890; 4,707,367; 5,709,895; and 6,932,982. Low temperature quenching, as disclosed, is achieved in a bath of volatile organic fluids, exemplarily isopropanol, at temperatures ranging as low as −15° C. to −25° C. or similarly in liquid nitrogen to as low as −200° C. without detrimental effects on the pellets formed.

U.S. Pat. No. 3,041,180 discloses hot face extrusion through air into a cold volatile organic liquid or into a non-volatile liquid that must be rinsed by a second liquid that is volatile. The strands formed are broken by impact on cooling. Volatile fluids include kerosene, petroleum ether, methyl alcohol, acetone, methyl ethyl ketone, limonene, benzene, and toluene. Non-volatile fluids include mineral oil, butyl stearate, vegetable oils and hydrogenated vegetable oils, and brominated vegetable oils. Quench temperatures less than room temperature to as low as 0° F. are disclosed to minimize fire hazards. The choice of solvents, as disclosed, is useful in the extraction of excess oils from the pellets formed.

Underliquid pelletization of molten polymer is disclosed in the United Kingdom Patent No. GB 1,143,182 wherein use of water or aqueous solutions are preferred for use as a cooling liquid, and preferably in a temperature range of 30° C. to 50° C. Other liquids, particularly glycol-water mixtures are cited by way of example when it is desired to utilize a cooling liquid above 100° C. US Patent Application Publication No. 20050062186 similarly discloses pressure-resistant granulation in a water/glycol mixture to produce polyester granules at as high a temperature as is possible for increasing the intrinsic viscosity thereof. Both documents remain silent as to use of other fluids and for use in other processes.

The use of liquid hydrocarbons including paraffins and aromatic hydrocarbons, mineral oils, vegetable oils, or other organic solvents is disclosed in U.S. Pat. No. 6,632,389 wherein the pellets disclosed are comprised of biologically active substances in a thermoplastic matrix that has different solubilities at different pH. The document remains silent in consideration of non-polymeric and minimal shear-sensitive materials. The document remains silent as to fluidic processes other than pelletization as well as to separation procedures for non-volatile fluids including mineral oil, vegetable oils and the like that are not removed by conventional drying processes.

U.S. Pat. No. 7,329,723 discloses the use of any conventional pelletization or dicing method, be it hot or cold, strand, pastille, hot face, underwater, or centrifugal such that the amorphous pellets thusly generated can be introduced into a liquid medium of at least 140° C. Suitable liquids as disclosed in the document include water, polyalkylene glycols, particularly diethylene glycol and triethylene glycol, alcohols, and aqueous solutions of these. Importantly, the pressure in the liquid medium zone is maintained at or above the vapor pressure of that medium to prevent boiling to insure that the pellets remain submerged. The principle disclosure of this document is for thermal crystallization of solid polyester polymer pellets. The document remains silent as to other fluids, materials, and processes.

Additionally, crystallization processes and equipment are also disclosed by the assignee exemplarily including U.S. Pat. No. 7,157,032; US Patent Application Publication Nos. 20050110182, 20070132134; European Patent Application No. EP 1 684 961; World Patent Application Publication Nos. WO2005/051623 and WO2006/127698. These patents and applications are all owned by the assignee and are included herein by way of reference in their entirety.

Crystallization of polyester pellets utilizing a heated liquid medium is disclosed in U.S. Pat. No. 5,532,335. An aqueous ethylene glycol solution is disclosed exemplarily at 260° F. and 50 psi absolute pressure to ensure that a liquid state is maintained throughout the crystallization process. Wherein it is anticipated that the sticking temperature of the polyester pellets can exceed 212° F., it is disclosed that higher alcohols, particularly hexanol, can be used at atmospheric pressure to circumvent the requirement for pressurization wherein water is a liquid medium component. The document remains silent on the use of fluids and combinations of fluids for processes other than crystallization and for materials other than polyesters and copolyesters.

German Patent Application No. DE 198 48 245 and World Patent Application Publication No. WO2000/023497 disclose the use of aqueous solutions of ethylene glycol or triethylene glycol for crystallization of thermoplastic polyesters and copolyesters at temperatures below 100° C. Wherein temperatures in excess of 100° C. are necessary, it is preferred to use ethylene glycol, triethylene glycol, and combinations thereof. The document remains silent as to the use of other materials, other fluids and fluid combinations, and other processes. It is similarly silent as to the practical removal of the ethylene glycol (literature boiling point, 196° C. to 198° C.), triethylene glycol (literature boiling point, 125° C. to 127° C. at 0.1 mm Hg), and mixtures thereof from the pellets on completion of the crystallization process. A two step process is disclose in which strands are cooled and pelletized and then arrive as an intermediate product to a second liquid bath for crystallization.

Similarly, dryer equipment has been used by the assignee of the present invention for many years as demonstrated in the prior art disclosures including, for example, U.S. Pat. Nos. 3,458,045; 4,218,323; 4,447,325; 4,565,015; 4,896,435; 5,265,347; 5,638,606; 6,138,375; 6,237,244; 6,739,457; 6,807,748; 7,024,794; US Patent Application Publication No. 20060130353; World Patent Application Publication No. WO2006/069022; German Patents and Applications including DE 19 53 741, DE 28 19 443, DE 43 30 078, DE 93 20 744, DE 197 08 988; and European Patents including EP 1 033 545, EP 1 123 480, EP 1 602 888, EP 1 647 788, EP 1 650 516, and EP 1 830 963. These patents and applications are all owned by the assignee and are included herein by way of reference in their entirety.

Post-processing manipulations as used herein can include thermal manipulation, enhanced defluidizing, pellet coating, particle sizing, storage, and packaging of the pellets thusly formed, and are well-known to those skilled in the art.

### BRIEF SUMMARY OF THE INVENTION

Briefly described, in preferred form, the present invention is a process for pelletization, transport, defluidizing, and post-processing of non-polymeric and minimally shear-sensitive polymeric materials, low melting materials, tacky materials, as well as hygroscopic, moisture-sensitive, and water-soluble materials, polymeric and non-polymeric, that utilizes at least one fluid to produce pellets of those materials. The fluids and combination of fluids utilized provide at least one of a wide range of temperatures for that processing, processing at a multiplicity of conditions, control of physical, mechanical, and/or chemical properties of the pellets produced, control of moisture content, rheological control of pellet formation and processing, control of pellet porosity, control of rinsing, washing, extraction, and impregnation processes of the pellets produced, and control of coating processes including reactive coatings for those pellets.

The pelletization process of the present invention can result in two pathways leading to formation of dry pellets and alternatively to formation of a pellet/fluid slurry. Pellets conventionally optionally can be cooled, coated, and/or transported for other post-processing manipulations as is known to those skilled in the art. Alternatively the pellets produced can be introduced into a fluid to form a pellet/liquid slurry.

The pellet/liquid slurry, produced directly by the pelletization process or alternatively as heretofore described can undergo further manipulation by at least one of cooling, warming, solvent extraction of pellets including moisture withdrawal, transportation of pellets, impregnation of pellets with pressurization, fluid removal, conditioning of pellets with varying residence time, wet coating of pellets, and rinsing of pellets, by way of example. Subsequently, a multiplicity of these pellet/slurry manipulations can be performed sequentially to produce two products including a pellet slurry appropriate to a specific end-use and alternatively, following solvent removal and defluidizing, a pellet similarly suitable for a specific end-use. The pellets and pellet/slurries thusly formed can alternatively be subjected to additional post-processing manipulations as is known to those skilled in the art.

The fluids utilized singly, multiply, and in combination for the manipulations can be the same or different for each of the processes as subjected to similar or different processing conditions. These fluids exemplarily include water, organic liquids, liquid oligomers, liquid polymers and copolymers, oils, dispersions, emulsions, solutions, reactive liquids and liquid components, and many combinations thereof. Similarly the fluids can act as solvents, as selective solvents for a specific component or combination of components, and alternatively, as a non-solvent.

The fluids utilized singly, multiply, and in combination, for processing can include water, aqueous solutions, aqueous dispersions, aqueous emulsions, aqueous acids and bases, organic liquids including alcohols, amides, carbonates, esters, ethers, heterocyclics, ketones, phosphorus and sulfur containing esters, saturated and unsaturated hydrocarbons, halogenated hydrocarbons, oils, mineral oils, vegetable oils, fatty acids and esters, silicone oils, organic solutions, organic dispersions, organic emulsions, organic acids and bases, oligomers, polymers including copolymers, fluoropolymers, polymeric dispersions, polymeric emulsions, reactive materials including monomers and oligomers, reactive polymers, and many combinations thereof. Fluids similarly can include liquids under at least one of ambient, reduced, and elevated pressure and can include air and other inert gases. Fluids can be at least one of a solvent, a selective solvent, and a non-solvent for a material, a formulation, as well as for a component or combination of components of the material being processed.

As used herein, “defluidizing” generally means a process by which a pellet is made less wet, including, for example but not limited to, dewatering, drying, and/or demoisturizing. The defluidizing process can include, but is not limited to, transferring the pellets through a drying chamber, transferring the pellets through surrounding air, or utilizing a drying media, vibrating screen device, a stationary screen device, or centrifugal pellet dryer.

Further, as used herein, “conditioning” generally means a process that toughens or hardens a pellet, preferably crystallizing, but also including, for example but not limited to, vulcanizing, curing, crosslinking, completing or furthering a reaction, and/or making a pellet less tacky. It shall be understood that the aforementioned conditioning examples are dependent on the chemical composition and molecular structure of the pellet and thus a pellet can be slightly, substantially, or completely vulcanized, cured, crosslinked, or crystallized. For example, the pellet may be conditioned in amorphous form, semicrystalline form, crystalline form, or combinations thereof.

The preferred embodiment of the present invention is a method for pelletizing and processing material, comprising preparing at least one material into a viscous flowable form, wherein the melt viscosity of the at least one material is not affected by mechanical shear, pelletizing the at least one material into a plurality of pellets, and transporting the plurality of pellets utilizing at least one transport fluid through at least one processing step.

Another embodiment discloses at least one transport fluid that is in a temperature range above its melting point and below its boiling point, is below its flash point, and is below the melting range of the pellets.

In yet another embodiment, the at least one transport fluid is in a temperature range from at least approximately 5° C. above its melting point to at least approximately 5° C. below its boiling point, at least approximately 30° C. below its flash point, and is at least approximately 20° C. below the melting range of the pellets.

Still another embodiment discloses at least one transport fluid that is in a temperature range from at least approximately 10° C. above its melting point to at least approximately 10° C. below its boiling point, at least approximately 30° C. below its flash point, and is at least approximately 30° C. to approximately 100° C. below the melting range of the pellets.

Yet a different embodiment discloses that the material being pelletized is non-polymeric.

In a further embodiment, the material being pelletized is water-soluble.

Still another embodiment discloses that the material being pelletized is water-dispersible.

In an additional embodiment, the material being pelletized is water-sensitive.

Still another embodiment discloses that the material being pelletized is hygroscopic.

Yet another embodiment discloses that the material being pelletized melts at least at ambient temperature.

In another embodiment, the material being pelletized has at least surface tack at ambient temperature.

An additional embodiment discloses that the material being pelletized is not soluble in the at least one transport fluid.

In yet another embodiment the material being pelletized is an organic solid at ambient temperature.

In still another embodiment the organic solid is non-polymeric.

Another embodiment discloses that the organic solid is oligomeric.

Still another embodiment discloses that the organic solid is polymeric.

Additionally in an embodiment, the material being pelletized is a composite formulation.

In yet another embodiment, the processing step can be at least one of a fluid removal step, a rinsing step, a defluidizing step, a conditioning step, an extraction step, a heating step, a cooling step, a chemical modification step, a coating step, and an impregnation step.

In still another embodiment, the processing step is a multiplicity of sequential processing steps that can include, separately and independently, at least one of a fluid removal step, a rinsing step, a defluidizing step, a conditioning step, an extraction step, a heating step, a cooling step, a chemical modification step, a coating step, and an impregnation step.

Another embodiment discloses that the pelletizing step produces a pellet that can be combined with a first transport fluid to make a pellet slurry.

In a differing embodiment, the at least one transport fluid can be an aqueous liquid, an organic liquid, a polymeric liquid, and combinations thereof.

Still another embodiment discloses that the at least one transport fluid can be a dispersion.

Additionally, an embodiment discloses that the at least one transport fluid can be an emulsion.

In another embodiment, the at least one transport fluid can be a solution.

Still yet another embodiment discloses that the at least one transport fluid can be a coating formulation.

In an additional embodiment, the coating formulation can be comprised of at least one reactive component.

Yet another embodiment discloses that transporting the pellets can be accelerated by the injection of inert gas.

Another embodiment discloses that transporting the pellets can be carried out at atmospheric pressure.

Yet another embodiment discloses wherein preparing the at least one material includes mixing, melting, blending, or combinations thereof.

In an additional embodiment, the method can further comprise outputting a pellet-fluid slurry as a final output.

In yet another embodiment, the method can further comprise outputting a plurality of pellets as a final output.

Another embodiment discloses a method for pelletizing and processing material, comprising: preparing at least one material into a viscous flowable form, wherein the melt viscosity of the at least one material is not affected by mechanical shear, pelletizing the at least one material into a plurality of pellets utilizing at least a first transport fluid, and transporting the plurality of pellets utilizing at least a second transport fluid through at least one processing step.

Yet another embodiment discloses wherein the first transport fluid and the second transport fluid can be the same.

In yet another embodiment, the first transport fluid and the second transport fluid can be different.

Another embodiment discloses a system for pelletizing and processing material with at least one transport fluid, comprising at least one preparation component, wherein at least one material is prepared into a viscous flowable form, and wherein the melt viscosity of the at least one material is not affected by mechanical shear, at least one pelletization component, wherein the at least one material is pelletized into a plurality of pellets, and at least one processing component, wherein the plurality of pellets are further processed.

Additionally, an embodiment discloses an apparatus for pelletizing and processing material wherein the processing component can be at least one of a fluid removal component, a rinsing component, a defluidizing component, a conditioning component, an extraction component, a heating component, a cooling component, a chemical modification component, a coating component, and an impregnation component.

In a further embodiment, the apparatus for pelletizing and processing material discloses the processing component comprising a plurality of sequential processing components that can include, separately and independently, at least one of a fluid removal component, a rinsing component, a defluidizing component, a conditioning component, an extraction component, a heating component, a cooling component, a chemical modification component, a coating component, and an impregnation component.

An additional embodiment discloses wherein the preparation component is at least one of a mixing component, a blending component, and a melting component.

### BRIEF DESCRIPTION OF THE DRAWINGS

FIG. 1 is a flow chart diagram showing the process manipulations.

FIG. 2 is a schematic illustration of a preferred embodiment of the present invention including a feeding section and mixing sections of the mixing process system.

FIG. 2a is a schematic illustration of a feeder, a mixing vessel, medium pressure pump, and coarse screen changer.

FIG. 2b is a schematic illustration of a feeder, an extruder, gear pump, and screen changer.

FIG. 2c is a schematic illustration of a feeder, gear pump, and static mixer assembly.

FIG. 2d is a schematic illustration of a vertically configured static mixer with attached bypass diverter valve.

FIG. 2e is a schematic illustration of a feeder, mixing vessel, medium pressure pump, coarse screen changer, gear pump, static mixer, extruder, gear pump, and screen changer in series.

FIG. 2f is a schematic illustration of a feeder, an extruder, gear pump, screen changer, static mixer, extruder, gear pump, and screen changer is series.

FIG. 3 is a schematic illustration of a pelletization system and transport to dewatering and defluidizing system in series.

FIG. 4 is a schematic illustration of a comparative static mixer with gear pump and bypass pipe connected by three-way valves.

FIG. 5 is a schematic illustration of a vertically configured static mixer with attached bypass diverter valve.

FIG. 6 is a schematic illustration of a polymer diverter valve.

FIG. 7 is a schematic illustration of a one-piece die plate with heating elements in three configurations.

FIG. 8a illustrates the three configurations of the heating element extracted from the die plate.

FIG. 8b illustrates the three configurations of the heating element positionally placed individually in side view.

FIG. 9 is a schematic illustration of a removable-center die.

FIG. 10 is an expanded view illustration of the components of a removable center-heated die.

FIG. 11 is a schematic illustration of a single-body insulated die.

FIG. 12 is an expanded view illustration of an insulated tapered body removable insert die.

FIG. 13 is a schematic illustration of a die body with cutting shroud.

FIG. 14 is a schematic illustration of a die body and two-piece cutting shroud.

FIG. 15 is an expanded view illustration of a comparative two-piece cutting shroud.

FIG. 16a is a schematic illustration of a complete assembly of a comparative two-piece cutting shroud.

FIG. 16b is a cross-sectional illustration of an alternative cutting shroud inlet and outlet design.

FIG. 16c is a schematic face-view illustration of the alternative cutting shroud inlet and outlet design of FIG. 16b.

FIG. 17 is a schematic illustration of a die body and non-fluid cutting shroud.

FIG. 18a is a schematic face-view illustration of a round to oval non-fluid cutting shroud tapering to outlet.

FIG. 18b is a schematic face-view illustration of a square to rectangular non-fluid cutting shroud tapering to outlet.

FIG. 18c is a schematic face-view illustration of a hexagonal non-fluid cutting shroud tapering to outlet.

FIG. 19 is a schematic illustration of a pelletizer with attached cutting shroud showing the die.

FIG. 20 is a schematic illustration of a die attached to a cutting shroud containing a flow guide.

FIG. 21a is a schematic illustration of a comparative flow guide.

FIG. 21b is a schematic illustration of a second configuration of a comparative flow guide.

FIG. 22 is a schematic illustration of a comparative flexible cutter hub with exploded view of flexible hub component.

FIG. 23a is a schematic view of a portion of a streamline cutter hub.

FIG. 23b is a schematic view of the streamline cutter hub rotated in perspective relative to FIG. 23a.

FIG. 23c is a cross-sectional view of the streamline cutter hub in FIG. 23a.

FIG. 24 is a schematic illustration of a steep angle cutter hub.

FIG. 25a is a schematic illustration of a comparative cutter hub with attached normal angle blade.

FIG. 25b is a schematic illustration of a steep angle cutter hub with attached blade.

FIG. 25c is a schematic illustration of a comparative perpendicular angle cutter hub with attached non-tapered or square-cut blunted tip blade.

FIG. 25d is a schematic illustration of a cutter hub with attached reduced thickness blade at normal angle.

FIG. 26 is a schematic illustration of a cutter hub with cutting angle displaced from centerline of cutter hub.

FIG. 27 is a schematic illustration of a comparative bypass.

FIG. 28 is a schematic illustration showing the apparatus for inert gas injection into the slurry line from the pelletizer to the dryer.

FIG. 29 is a schematic illustration showing the apparatus for inert gas injection into the slurry line from the pelletizer to the dryer including an expanded view of the ball valve in the slurry line.

FIGS. 30a and 30b are schematic illustrations of a comparative self-cleaning dryer.

FIG. 31 is a schematic illustration of the fluid removal portion of the self-cleaning dryer in FIGS. 30a and 30b.

FIG. 32 is a schematic illustration of a second comparative dryer with attached fluid removal section.

FIG. 33 is a schematic illustration of a reservoir.

FIG. 34 is a schematic illustration of a dryer showing fluid removal screen and centrifugal defluidizing screen positioning.

FIG. 35 illustrates a dryer screen with deflector bars.

FIG. 36 is a cross-sectional illustration of the screen with deflector bars in FIG. 35.

FIG. 37 illustrates a dryer screen of a configuration not requiring deflector bars.

FIG. 38 is a cross-sectional illustration of the dryer screen of FIG. 37 without deflector bars.

FIG. 39 illustrates an enlarged edge-on view of a three-layer screen.

FIG. 40 illustrates an enlarged edge-on view of a two-layer screen.

FIG. 41 illustrates an enlarged external view of a multi-layer screen following FIG. 40.

FIG. 42 is a schematic drawing illustration a pellet conditioning system and dryer.

FIG. 43a is a top schematic view of a vibratory unit with deflector weir and pan for powder treatment of pellets.

FIG. 43b is a side view illustration of a vibratory unit with deflector weir and pan for powder treatment of pellets.

FIG. 44a is a top schematic view of a vibratory unit with deflector weir and retainer weirs for enhanced conditioning of pellets.

FIG. 44b is a side view illustration of a vibratory unit with deflector weir and retainer weirs for enhanced conditioning of pellets.

FIG. 45 is a schematic illustration of an apparatus for pelletization, pressurized transport, fluid removal, defluidizing, and a post-processing section.

FIG. 46 is a schematic illustration of a multiple loop pressurized transport fluid bypass.

FIG. 47 is a schematic illustration of an inline pressure generation unit consisting of a bypass loop, agglomerate filtration basket and three biconical devices in a series of decreasing diameter flow restriction tubes.

FIG. 48 is a schematic illustration of the slurry line filtration basket of FIG. 47.

FIG. 49 is a schematic illustration of one biconical device of FIG. 47.

FIG. 50a is a schematic illustration of a pressurized fluid removal device.

FIG. 50b is a cross-sectional schematic illustration of a pressurized fluid removal device.

### DETAILED DESCRIPTION

Although preferred embodiments of the invention are explained in detail, it is to be understood that other embodiments are possible. Accordingly, it is not intended that the invention is to be limited in its scope to the details of construction and arrangement of components set forth in the following description or illustrated in the drawings. The invention is capable of other embodiments and of being practiced or carried out in various ways. Also, in describing the preferred embodiments, specific terminology will be resorted to for the sake of clarity.

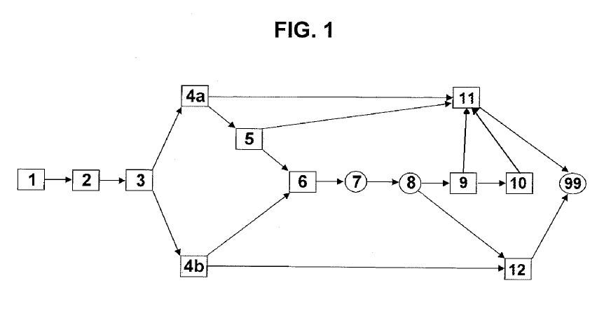

The present fluidic pelletization, transport, and defluidizing system as shown diagrammatically in FIG. 1 includes a feeding or filling section 1 that provides material into a mixing, melting and/or blending section or section 2. The mixing section 2 is fittingly attached to a pelletizing section 3 that subsequently produces pellets 4a or a pellet slurry 4b.

Pellets 4a can be processed as is to finished pellets 11 or can undergo a pellet manipulation 5 that can be a solid manipulation leading to finished pellets 11 or can be a first slurry manipulation 6. Similarly, pellet slurry 4b can be processed as is to finished pellet slurry 12 or can undergo first slurry manipulation 6. Subsequently, first slurry manipulation 6 can undergo optional second slurry manipulation 7 and/or optional third slurry manipulation 8 to form intermediate pellets 9 or finished pellet slurry 12. Intermediate pellets 9 can undergo intermediate pellet manipulation 10 to form finished pellets 11 or can directly form finished pellets 11. Optionally, finished pellets 11 or finished pellet slurry 12 can undergo post-processing manipulations 99.

The previous section/equipment description facilitates an understanding of the method steps of the present invention. As such, the present invention can comprise a method for multiple sequential process to achieve the fluidic pelletization, transport, and/or defluidizing of materials wherein the method comprises the steps of feeding material from the feeding or filling section 1 to the mixing, melting and/or blending section or sections 2.

A next process of the present invention can include extruding the material in section 2. A further processing step is pelletizing the material in pelletizing section 3 to produce pellets 4a. A pellet manipulation 5 can produce at least a slurry that is transported to first slurry manipulation 6. This slurry is transported to an optional second slurry manipulation 7 and from there can be transported to an optional third slurry manipulation 8.

An alternative process of the present invention can include extruding the material in section 2. A further processing step is pelletizing the material in pelletizing section 3 to produce pellet slurry 4b. The pellet slurry 4b subsequently is transported to first slurry manipulation 6. This slurry is transported to an optional second slurry manipulation 7 and from there can be transported to an optional third slurry manipulation 8.

The first slurry manipulation 6 and optionally subsequent second slurry manipulation 7 and/or third slurry manipulation 8 can produce intermediate pellets 9 that can become finished pellets 11 or can undergo intermediate pellet manipulation 10 to form finished pellets 11. Alternatively, this process of the present invention can produce finished pellet slurry 12. Additionally, finished pellets 11 and finished pellet slurry 12 can undergo optional post-processing manipulations 99.

Each of these steps of the present invention is operated at processing conditions, wherein the particular processing conditions of each step can be different from other steps of the system. For example, the step of mixing the polymeric material can occur at “mixing processing conditions” (temperatures, pressures, etc.), and the step of extruding the polymeric material can occur at “extruding processing conditions” (temperatures, pressures, etc.). It can be that at least one common condition of both the mixing processing conditions and the extruding processing conditions are different, for example, the temperature that each step operates, while another common condition, the pressure, is the same in each step.

Analogously, the fluids involved in the slurry manipulations can differ in composition, in temperature, and in intended use. Exemplarily, a single fluid can be used at different temperatures to pelletize the material and then condition the material. Similarly, different fluids can be used to pelletize the material, condition the material, and subsequently defluidize the material. Details of the processes involved and the slurry manipulations are described hereinbelow.

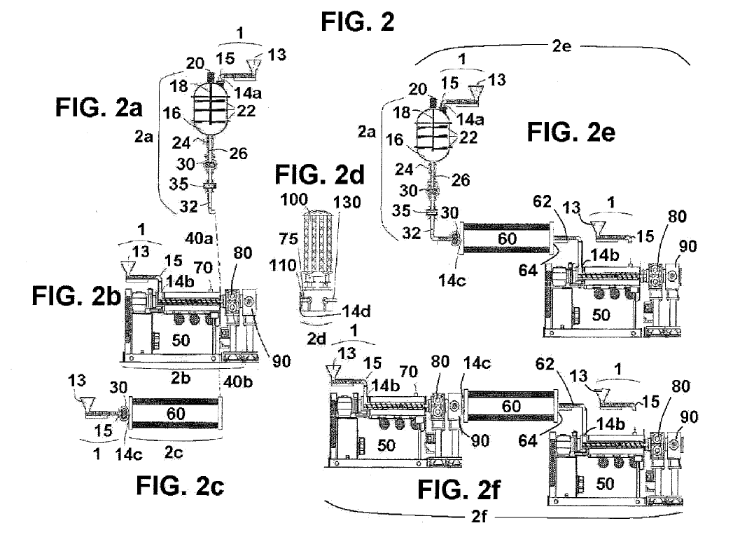

Turning now to FIG. 2, the apparatus includes the feeding or filling section 1 that provides material or component materials into the mixing, melting, and/or blending section or sections 2 (shown as 2a to 2c, 2e and 2f in respective FIGS. 2a, 2b, 2c, 2e, and 2f). The material or component materials are fed manually as a solid or liquid. Preferably, liquids can be pumped or metered, not shown, into the mixing apparatus and solids can be added via a feed screw 13 as indicated in section FIGS. 2a, 2b, 2c, 2e, and 2f or by other appropriate device. Feeding can be accomplished gravimetrically or volumetrically and preferably is controlled through mechanical and/or electronic feed-back mechanisms as are readily known to those skilled in the art. One or more similar or different feeding mechanisms can be used, and can be placed at the same or different entry points in mixing section 2 as indicated by mixing inlet 14a, 14b, 14c, or 14d. The feeding components can be ambient in temperature, heated, or cooled and can be at atmospheric conditions or pressurized, purged with air or an inert medium such as, but not limited to, argon or nitrogen preferentially, or can be subjected to a vacuum or partial vacuum to expedite flow into mixing section 2 preferentially near the exit port of the feeding device exemplary of that being the feed screw outlet 15.

The mixing section 2 of the present invention includes dynamic 2a, extrusional 2b, and/or static 2c mixing components that can be used individually or as a plurality of two or more of these component types interconnectedly attached in series, in tandem, and/or in parallel.

The feed screw outlet 15 of feeding section 1, FIG. 2a, is attached to the dynamic section 2a at one or more inlets exemplified by inlet 14a for the thermally controlled mixing vessel 16. The vessel chamber can be atmospheric or purged with air or inert gas, for example argon or preferably nitrogen. Components can be added continuously or portionwise with warming to temperature as required by a particular process. Mixing is achieved by rotation of the rotor 18 controlled by motor 20. Attached to rotor 18 are mixing blades 22 exemplary of which can be propeller or boat style, ploughshare style, delta or sigma style in single, double, or multiple configurations, and helical or helical dispersion blades. Alternatively, the vessel can be a kneader, Buss kneader, or Farrel internal mixer or it can be a ribbon blender, Banbury-type blender, horizontal mixer, vertical mixer, planetary mixer or equivalent devices known to those skilled in the art.

On reaching the appropriate pour point, valve 24 is opened and the fluid or molten material passes into and through pipe 26 and is drawn into booster pump 30. The booster pump 30 can be, for example, a centrifugal pump or a positive displacement reciprocating or rotary pump. Preferably the booster pump 30 is rotary and can be a peristaltic, vane, screw, lobe, progressive cavity, or more preferably, a gear pump. The gear pump can be high precision or preferably is open clearance and generates an intermediate pressure, typically up to approximately 33 bar, and preferably less than approximately 10 bar. The pump pressure can vary, and need be sufficient to force the melt through coarse filter 35 that can be a candle filter, basket filter, or screen changer, and is more preferably a basket filter of 20 mesh or coarser. The coarse filter 35 removes larger particles, agglomerates, or granular material from the melt as it flows to and through pipe 32. The dotted line 40a indicates the connection to melt pump 80.

Alternatively the feeding section 1 in FIG. 2b is connectedly attached via feed screw outlet 15 to the mixing section 2, and more specifically extrusional mixing section 2b, at one or more inlets as exemplified by inlet 14b to an extruder 50 that optionally can be, but is not limited to, a pellet mill, a single screw, twin screw, multiple screw or ring extruder, or a ram extruder and is preferably a single screw, and more preferably is a twin screw extruder. The sections or zones of the screw should feed, mix, and convey the material simultaneously providing sufficient energy, thermal and mechanical, to melt, mix, and uniformly disperse and distribute the material or materials for the pelletization to follow. The extruder 50, preferably the twin screw extruder, optionally can be purged with air or an inert gas, of which nitrogen or argon are preferential but not limiting, and additionally can have one or more vent ports some or all of which can be fitted with one or more vacuum attachments or other exhaust mechanism or mechanisms as is understood by those skilled in the art. Vent ports or appropriate exhaust mechanisms facilitate removal of gases, unwanted volatiles such as residual monomer or byproducts, and/or impurities. Venting should be used with caution and positionally placed such that volatile components essential to the formulation are not lost or compromised after introduction to the mixing process. The configuration of the screw should be satisfactory to achieve an appropriate level of feeding, mixing dispersively and/or distributively, melting, blending, and throughput rate determined by the formulation and processing requirements. The extruder 50 is attachedly connected to the melt pump 80 as shown in FIG. 2b at the locus similarly identified by the dotted line 40a for dynamic mixing section 2a illustrated in FIG. 2a.

Analogously, feeding section 1 can be connected via feed screw outlet 15 to inlet 14c in the static mixing section 2c in FIG. 2c and/or to inlet 14d in the bypass static mixing section 2d in FIG. 2d. Process operations can dictate the use of a booster pump 30 and/or a melt pump 80 to facilitate transfer and pressurization of the material flow into the static mixer 60. Static mixer 60 is connected to melt pump 80 positionally as indicated by dotted line 40b in FIG. 2c.

Mixing sections can be used alone or in combination where dynamic, extrusional, and/or static mixing as described herein are connected in series and/or in parallel. Exemplary of this is dynamic mixing section 2a attached directly to static mixing section 2c at inlet 14c or extrusional mixing section 2b attached directly to static mixing section 2c at inlet 14c or alternatively to static mixing section 2c at inlet 14d of bypass static mixer 100 as detailed below. Extrusional mixing section 2b alternatively can be attached to another extrusional mixing section in series and/or in parallel of similar or different design type or configuration. Temperatures and process parameters can be the same or different in the various mixing sections and mixing units can be attached in combinations greater than two serially or otherwise.

The conventional limitations of FIGS. 2a, 2b, and 2c alone or serially in combination as heretofore described remain problematic in that cooling, though present in these components, does not have a level of control and narrowness of definition of degree in temperature to acceptably be able to produce high quality pellets of low melting point and/or of narrow melting range materials. Secondarily, the mixing sections as described above are limited in their capacity to achieve efficient and uniform dispersive mixing and are further limited in their ability to reduce or eliminate phase separation of blended materials including pastes, formulations, dispersions, and solutions. Furthermore, non-polymeric materials and materials of minimal or no shear sensitivity defined herein as materials that change viscosity with change in temperature but do not exhibit a change or only a very small change in viscosity by introduction of shear, for example, necessitate high control of thermal energy, frictional generation of heat, and mechanical energy, where applicable, thus requiring heating and/or cooling to effect a processable melt, defined herein as a material capable of being melted, extruded and pelletized, without leading to undesirable degradation. For these materials the temperature transition from fluid to more viscous semi-solid or solid is typically narrow and can be low relative to ambient temperature, and control of this is extremely limited in mixing sections heretofore described.

In consideration of these challenges, a preferred embodiment of the present invention is exemplified in FIG. 2e, in which the dynamic mixing section 2a (FIG. 2a) is fixedly attached to booster pump 30 affixed to inlet 14c of static mixer 60. An insulated conveyance pipe 62 is connectedly attached to static mixer outlet 64 and inlet 14b of cooling extruder 50. The screw configuration of cooling extruder 50 can provide rigorous mixing and propagation of the melt to and through the zones or sections of the extruder distal from the inlet 14b. One or more side feeders indicated as section 1 and illustrated without attachment to cooling extruder 50 can be variably positioned at inlets along the extrusion zones as needed for a particular process.

A more preferred embodiment of the present invention, FIG. 2f, includes an extrusional mixing section 2, previously described for FIG. 2b, fixedly attached to optional melt pump 80 and screen changer 90, described below. Static mixer 60 is attached thereto at inlet 14c and connectedly attached at static mixer outlet 64 to conveyance pipe 62 subsequently attached to cooling extruder 50, described above, at inlet 14b.

Ingredients, liquid or solid, can be added utilizing the feeding section (or sections) 1 herein described connected at one or more locations including, but not limited to, inlets 14a, 14b, 14c, or 14d. For vessel mixing, components are added at inlet 14a or preferably for any volatiles at inlet position 75 proximal to inlet 14d. Where vessel mixing is attached serially to static mixing (not shown in FIG. 2), addition of the any volatiles is preferably performed at the inlet of the static mixer as is exemplified by a modification of inlet 14c for static mixer 60 (FIG. 2c) as is understood by one skilled in the art. For extrusional mixing, components are added at inlet 14b, and for any volatiles, preferably at an inlet positionally near the end of the extruder 50 as indicated by inlet position 70 or alternatively at inlet position 75 proximal to inlet 14d. For extrusional mixing serially attached to static mixing prior to gear pump 80 (not shown in FIG. 2), addition of components can be accomplished at the inlet of the static mixer as is exemplified by a modification of inlet 14c for static mixer 60 (FIG. 2c) as previously described for serial vessel and static mixing. For static mixing, introduction of components can be done at inlet 14c in FIG. 2c or for volatiles at inlet position 75 proximal to inlet 14d in FIG. 2d.

Various levels of mixing and shear, when applicable, are achieved by the differing styles of mixing processes. Static mixing typically has the least shear and relies more on thermal energy. Dynamic mixing depends to a large degree on blade design and mixer design. Extrusional mixing varies with type of screw, number of screws, and the screw profile and is quite capable of significant generation of shear energy. Therefore, energy is introduced into the mixing process in terms of both shear or mechanical energy, where applicable, and thermal energy with additional heating being generated by frictional forces of the material as it is propagated through the mixing devices. Heating and/or cooling of the units can be achieved, for example, electrically, by steam, or by circulation of thermally controlled liquids such as oil or water. Mixing continues until the material or formulation reaches an appropriate temperature or other criterion of consistency or viscosity as determined or known specifically for the process by those appropriately skilled in the art.

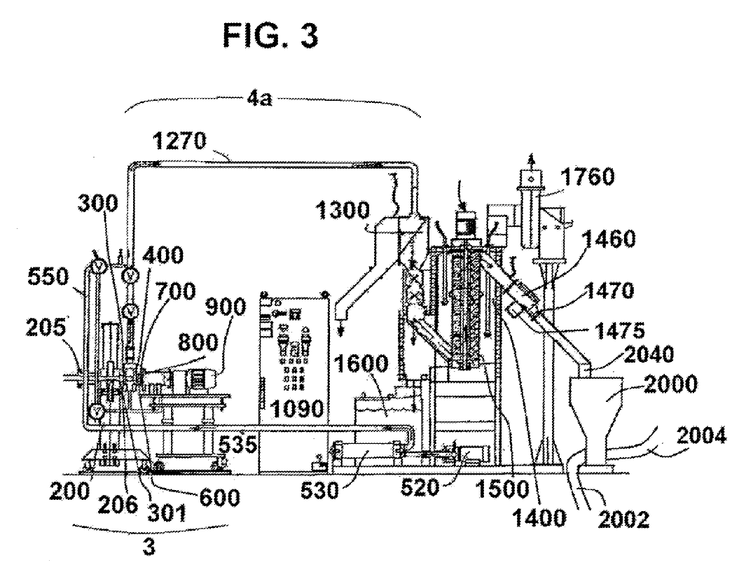

Referring again to FIG. 2, on exit from the mixing stage 2a, 2b, 2c, 2d, 2e, 2f, or any combination thereof, the molten or fluidized material optionally passes to and through optional melt pump 80 that generates additional pressure on the melt, preferably at least approximately 10 bar and more preferably between approximately 20 to approximately 250 bar or more. Pressures required are dependent on the material being processed and are significantly affected by the pelletization process (section 3 of FIG. 3) that follows mixing as well as on the throughput rate or flow rate of the process. Melt pump 80 can be a centrifugal or positive displacement reciprocating or rotary pump, and preferably is a rotary pump that can be a peristaltic, vane, screw, lobe, progressive cavity, or gear pump, and more preferably is a gear pump. Seals should be compatible with the material being processed, chemically and mechanically, the details of which are well understood by those skilled in the art.

The pressurized melt passes through an optional filter 90, FIGS. 2b, 2e, and 2f, that is preferably a basket filter or screen changer, and is more preferably a screen changer of 200 mesh or coarser, and even more preferably a multilayer screen changer of two or more screens of differing mesh, most preferably a series of filters exemplary of which is 20 mesh, 40 mesh, and 80 mesh. The screen changer can be manual, plate, slide plate, rotary plate, single or dual bolt, and can be continuous or discontinuous.

The use of melt pump 80 and/or filter 90 is strongly and optionally dependent on the containment of volatile ingredients in the formulation. Pressures can be sufficient from extrusional mixing 2b to forego use of melt pump 80, whereas use of static and/or dynamic mixing, 2c or 2a respectively, can require facilitation of pressurization to insure progress through and egress of the material or formulation from the apparatus. The filter 90 provides a safety mechanism, where employed, to insure oversize particles, lumps, amorphous masses, or agglomerates are not propagated to the bypass static mixer 100 or pelletization process section 3, FIG. 3. Alternatively, introduction of volatile components can be performed at inlet position 75 proximal to inlet 14d in FIG. 2d as previously delineated. Where additional pressurization and/or screening are a requisite process component, introduction via inlet position 75 proximal to inlet 14d is a preferred approach.

Static mixer 60 in FIGS. 2c, 2e, and 2f can be used to heat the mixture being formed to generate a uniform molten mass or can be used effectively as a melt cooler to reduce the temperature of the molten mass. When static mixers are used in series, each unit can be used to heat and further mix the material or formulation wherein the temperatures, design, geometries and configurations, physical sizes, and process conditions can be the same or different among mixers. A static mixer in the series can be heating the material to achieve better temperature and melt uniformity, and improved dispersive and distributive mixing, where applicable, whereas a second static mixer can actually be cooling the material to facilitate further processing, for example. A static mixer 60 or melt cooler is a heat exchanger of the coil type, scrape wall, shell and tube design, or U-style tube design or other comparable style and preferably is a shell and tube design that includes static mixing blades of appropriate configuration within the individual tubes to further mix the material and bring more of the material into intimate contact with the wall of the tube outside of which is a flow preferably of, but not limited to, oil or water to provide warming or cooling as appropriate. The temperature and flow rate of the circulating medium is carefully regulated by a control unit, not shown. An important criterion for selection of conditions in static mixing or melt cooling is to do a maximum amount of work to effect mixing with a minimum pressure drop while maintaining the pressure required for proper admixture. Pressures generated by the extruder 50 and/or the melt pump 80, where present, should be sufficient to maintain flow of the molten or fluid mass through the filter 90, where applicable, into and through the bypass static mixer 100, and into and through the pelletization section 3, FIG. 3. Alternatively, an optional melt pump 80 can be positionally attached to outlet 130, FIG. 2d and inlet 205, FIG. 3, to maintain or increase pressure into and through the pelletization section 3.

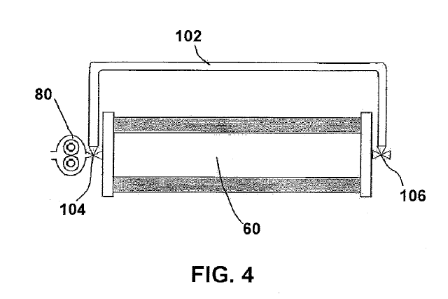

The optional bypass static mixer 100 in FIG. 2d has a distinct advantage over prior art devices that would have to physically be removed from the melt flow pathway for maintenance or cleaning, and is not always necessary in a particular process. To simplify this challenge, a “spool” or straight large bore pipe that can or can not have a coolant connection can be inserted into the pathway to allow flow effectively bypassing the unnecessary static mixer. Alternatively, a bypass line 102 can be inserted into the flow path as shown in FIG. 4 with a diverter valve 104 used to switch flow from the static mixer 60 into the bypass line 102. Similarly a second diverter valve 106 can be used to reconnect the bypass flow back into the mainstream at or near the outlet of static mixer 60.

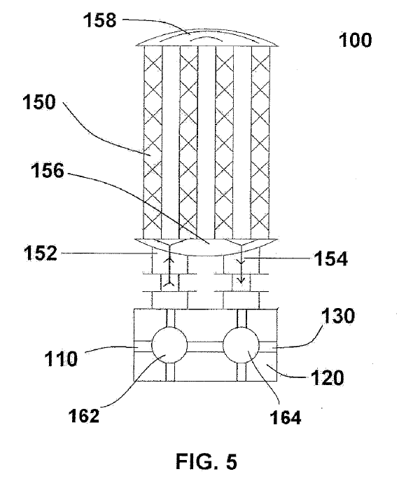

The outlet of optional filter 90 is attachedly connected to the bypass static mixer 100 in FIG. 2d via inlet 110 of bypass diverter valve 120 detailed in FIG. 5. Inlet 110 directs melt flow into the static mixing component 150 of the bypass static mixer 100 through static mixer inlet 152. The melt flow passes through static mixing component 150 and exits through static mixer outlet 154 into the outlet 130 of the bypass diverter valve 120. A two-pass or double pass heat exchanger is illustrated in FIG. 5 wherein the base 156 of the static mixing component 150 is attachedly connected as described through inlet 152 and outlet 154 to the bypass diverter valve 120. The top 158 of the static mixing component 150 is distal from the bypass diverter valve 120. The orientation of the static mixer 100 and bypass diverter valve 120 as herein described can be pendulous, horizontal, or vertically disposed or can be positionally inclined at many angles inclusive between the aforementioned positions.

The valve components 162 and 164 are preferably in the form of movable bolts, valve component 162 being upstream of the static mixing component 150 and valve component 164 is similarly downstream. The bolts contain, but are not limited to, two (2) bores exemplary of which is valve component 164, or three (3) bores of which valve component 162 is an example, or more bores. The respective bores can have various orientations, for example, they can be straight-through, form a 90° turn, or be in the shape of a “tee or T”, and are specifically placed along the length of the bolt. Each of these bores is positionally placed by means of a fluid-controlled cylinder or equivalent device, and will adjustably maintain good alignment with the proper inlets and/or outlets of the bypass diverter valve 120, based on the desired position required by the operator running the process, as will be understood by those skilled in the art. The positioning of the fluid powered cylinders, and thus the each bolt's position, can be controlled by manually operating a fluid flow valve or by automatic control such as by PLC, or both.

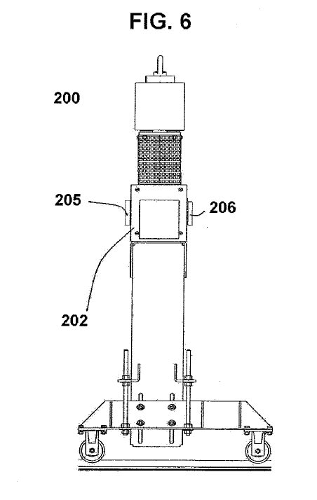

The component or components of the mixing section 2 are attachedly connected to the diverter valve 200, as indicated in FIG. 3 where the outlet 130, FIG. 2d, of the bypass static mixer 100 is attached to inlet 205, FIG. 3. FIG. 6 illustrates inlet 205 and outlet 206 attached to housing 202 of diverter valve 200. The movable diverter bolt, not illustrated, can be actuated electromechanically, hydraulically, pneumatically and many combinations thereof.

Use of surface treatments and coatings for components in sections 1 and 2 of FIG. 2 including vessels, extruders, gear pumps, screen changers, polymer diverter valves (FIG. 3), and static mixers or melt coolers are contemplated by the present invention and are included herein by way of reference without intending to be limited. Nitriding, carbonitriding, electrolytic plating, electroless plating, thermal hardening, flame spray techniques, and sintering techniques are exemplary of these surface treatments and coatings.

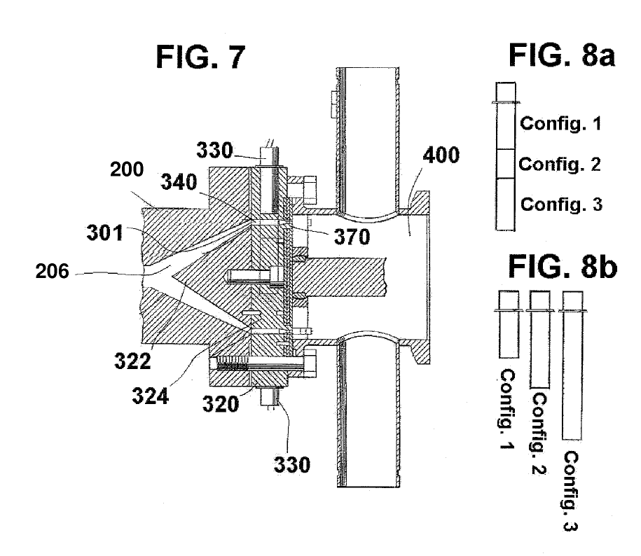

Referring again to FIG. 3, diverter valve 200 is attached at outlet 206 to the pelletization section 3 at inlet 301 of the die 320, with details illustrated in FIGS. 7, 8a, 8b, 9, 10, 11, 12, and 13.

The die 320 in FIG. 7 is a single-body style including a nose cone 322 attached to die body 324 into which are fitted heating elements 330 and through which are bored multiple die holes 340 that vary in number and orientation pattern and are preferably approximately 3.5 mm in diameter or smaller. The die holes 340 can be many combinations of design including, but not limited to, increasing or decreasing taper or cylindrical or many combinations thereof and segments can vary in length as necessitated by the process and materials. Preferably the die holes 340 are placed singularly or collectively in groups or pods in one or more concentric rings as determined by the diameter of the outlet 206 of the diverter valve 200 fittedly attached thereto. The die holes 340 can be at least one of round, oval, square, rectangular, triangular, pentagonal, hexagonal, polygonal, heart-shaped, star-shaped, dumbbell or dogbone shape, and many other geometries and designs without intending to be limited.

Heating elements 330 can be a cartridge or more preferably a coil type element and can be of sufficient length inside the die body 324 to remain outside the circumference of the die holes as illustrated in FIG. 7 and detailed in FIGS. 8a and 8b as configuration 1, or can extend into and near the center of the die body without passing the center in length, configuration 2 in FIGS. 8a and 8b, or can extend past the center in length but not of sufficient length to contact the ring of die holes diametrically opposed, (configuration 3). Positioning of the die holes will vary as would be readily recognized by one skilled in the art to accommodate the appropriate configuration of the heating elements 330 and one or more lengths or designs of heating elements are optionally included within the scope of the present invention.

Alternatively, die 320 can be of single-body construction heated by at least one band heater, not shown, that replaces heating elements 330 and circumferentially surrounds the die body 324. In yet another alternative, at least one coil heater, also not shown, can be used circumferentially surrounding die 320 comparable in application to the band heater. Similar modifications are intended to be understood as embodiments of the present invention in this and other die designs described hereinbelow.

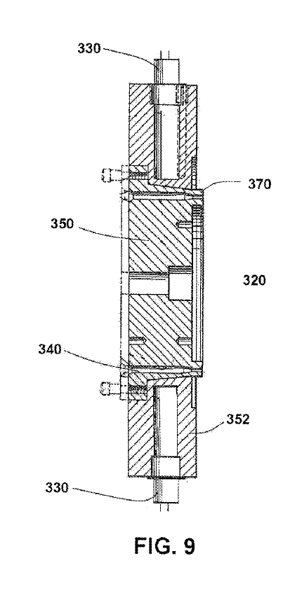

A preferred design of die 320 is illustrated in FIG. 9 in that the die body is of a removable center or insert configuration. The heating elements 330 are of a cartridge or, more preferably, a coil configuration and are inserted into the outer die body component 352 whereby they are constrained in length to suitably fit within the confines of the outer die body component 352. The die holes 340 are contained within removable insert 350 and are variable in design, dimension, and placement as detailed in the foregoing discussion. The removable insert 350 is fixedly attached to outer die body component 352 by known mechanisms.

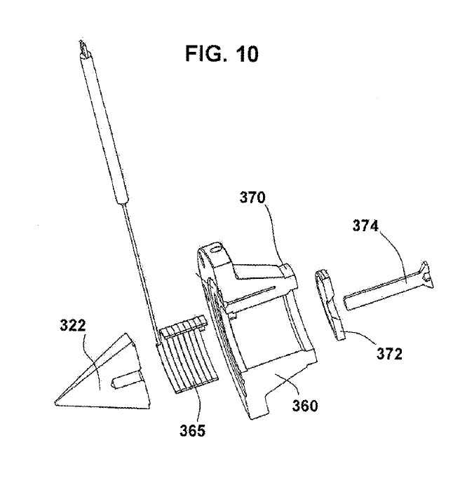

FIG. 10 shows an alternative design of die 320 in that the die body is of a removable center or insert configuration with multiple heating zones for enhanced heating efficiency and more facile thermal transfer to the molten or liquid materials as they pass through the die holes 340. The outer die body component, not shown, is comparable to that described for FIG. 9. The heated removable insert 360 of the alternative design has an open center to which is fitted a heating element 365, preferably a coiled heating element, that can be thermally controlled in common with other heating elements in the outer die body component or more preferably, is autonomously regulated thermally thus allowing multizone heating capacity within the die 320.

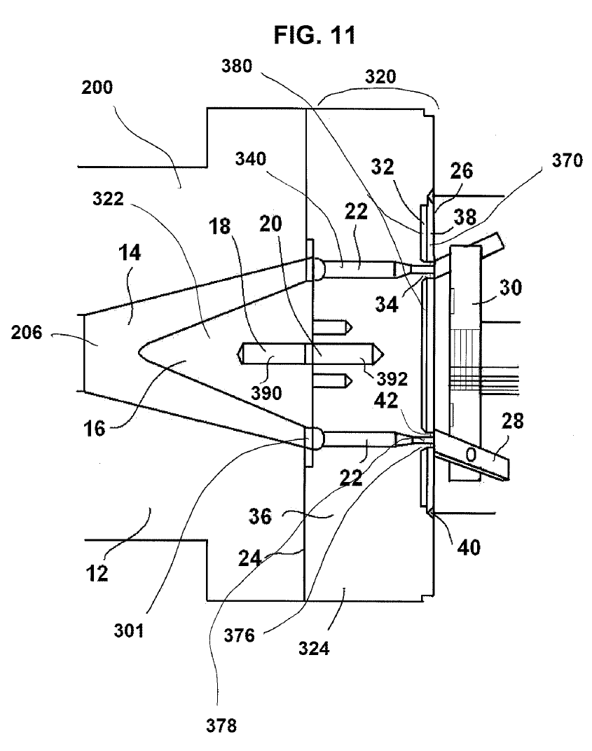

The die 320 illustrated in FIG. 11 is an alternative single-body style similar in design to that heretofore describe in FIG. 7 attached to diverter valve 200 at outlet 206 via inlet 301 of the die 320. Nose cone 322 is similarly attached to die body 324 into which are fitted heating elements as before, not shown, and through which are bored multiple die holes 340 that vary in number, orientation and design as previously described. Preferably the die holes 340 are placed singularly or collectively in groups or pods in one or more concentric rings as determined by the diameter of the outlet 206 of the diverter valve 200 fittedly attached thereto as before. Die body 324 contains insulating chamber 380 circumferentially positioned about the die body protrusions 376 through which penetrate outlets 376 of the die holes 340. The insulating chamber 380 can contain air or other inert gas and more preferably is a vacuum as is known to those skilled in the art.

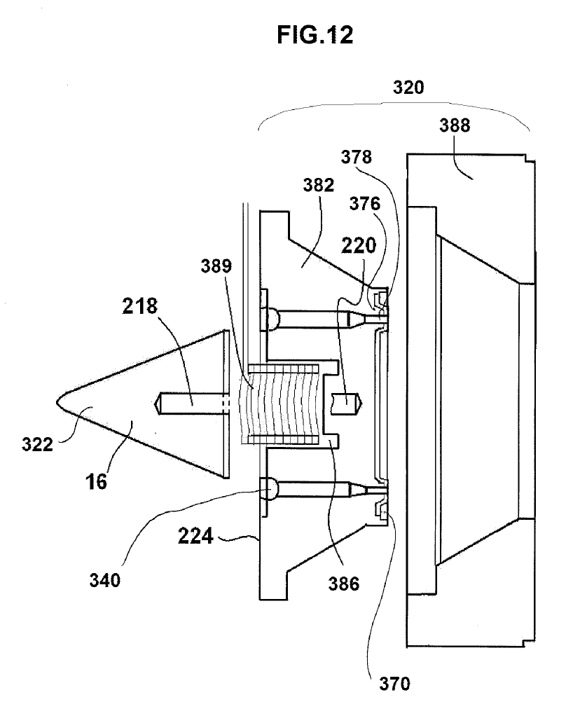

FIG. 12 illustrates an alternative tapered insert center-heated configuration for die body 320 in which the tapered removable insert 382 is constructed with recess 386 into which fits coiled heater 384. Covering this assembly is attachedly connected nose cone 322 as described hereinbelow. Tapered removable insert 382 contains insulating chamber 380 circumferentially positioned about the die body protrusions 376 through which penetrate outlets 378 of the die holes 340. The insulating chamber 380 can contain air or other inert gas and more preferably is a vacuum as heretofore discussed. The multiplicity of die holes 340 vary in number, orientation and design as previously described and are placed singularly or collectively in groups or pods in one or more concentric rings as determined by the diameter of the outlet 206 of the diverter valve 200 fittedly attached thereto as before. Tapered removable insert 382 is fittingly positioned in die base 388 to which is attachedly, albeit removably, connected.

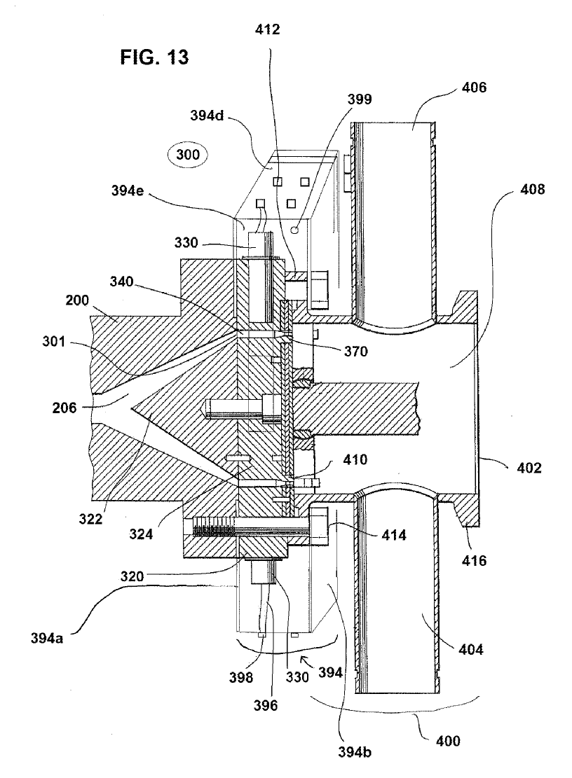

Yet another design configuration for die 320 is illustrated in FIG. 13 in which a shield 394 is attachedly connected to die 320. Heating element cable 396 is attachedly connected to heating element 300 and passes through shield 394 at orifice 398. Air or other inert gas can be purged into shield 394 through orifice 399 to provide additional protection from exposure of the die 320 to possible vapors thusly reducing the likelihood of or avoiding possible ignition of those vapors. (Reference numbers for FIG. 13 follow those from FIG. 7.) Purging can be accomplished by allowing flow of purge gas through unsealed or marginally sealed assembly junctions, not shown. Alternatively, an optional purge outlet orifice, not shown, can be affixed to shield 394 facilitating directed purge therethrough and facilitating optional recycling and/or purification of the purge as is understood by those skilled in the art.

Shield 394, as illustrated in FIG. 13, can be an assembly of backplate 394a, faceplate 394b, side plates 394c, and end plates 394d connected, by welding for example, and attachedly connected to the die body 324. Alternatively the shield 394 can be an assembly of the backplate 394a, side plates 394c, and end plates 394d attachedly connected to the die body 324 or to the diverter valve 200. Face plate 394b can be attachedly connected to die body 324 and is sealingly fitted onto the assembly and attachedly and removable affixed in position by bolting, clamping and many similar mechanisms as are known to those skilled in the art.

In yet another configuration, shield 394 can be an assembly of the faceplate 394b, side plates 394c, and end plates 394d attachedly connected to the die body 324. Backplate 394b can be attachedly connected to diverter valve 200 and is sealingly fitted onto the assembly and attachedly and removable affixed in position by bolting, clamping, and many similar mechanisms as are known to those skilled in the art.

The shield 394 is illustrated in FIG. 13 as a square to rectangular assembly by way of example and is not intended to be limiting. As such the shield 394 can be round, oval, hexagonal, polygonal, any geometry, and many combinations of geometries to accommodate structural design, facilitate functional operation, and/or to achieve aesthetic preferences as obviated by the apparatus and the maintenance necessitated thereof.

The die 320 in all configurations (FIGS. 7, 8a, 8b, 9, 10, 11, 12, and 13) can contain an appropriate fixedly attached hardface 370 that is preferably an abrasion resistant, wear resistant, and where required, a corrosion resistant material and through which pass the die holes 340 for extrusion of the molten or liquid extrudate. Tungsten carbide, titanium carbide, ceramics and combinations thereof, are common materials for hardface applications as is understood by those skilled in the art and are cited by way of example alone or in combination without intent to be limiting or otherwise restrictive within the scope of the present invention.

The bolting mechanism for the nose cone 322 is exemplarily illustrated in FIG. 10 by way of example without limitation. A cover plate 372 is positionally attached by bolt 374 to the face of the die body 320 or removable insert 350 or heated removable insert 360, FIGS. 7, 9, and 10 respectively, that can be less than or at least equal to the height dimension of the hardface 370. Alternatively, gasket material or other materials for sealing of the cover plate 372 can be used as required. Alternatively, nose cone 322 can be attached as illustrated in FIG. 11 wherein a rod, not shown, is threaded at both ends and is threadingly inserted into threaded nose cone recess 390 and threaded die body recess 392.

Diverter valve outlet 206, FIGS. 7, 11, and 13, is comprised of an inner bore that is tapered diametrically and conically in increasing diameter to create a chamber continuously and proportionately larger than nose cone 322 that inserts therein. The volume of the chamber thusly generated allows unobstructed flow of the process melt or other molten or liquid material to flow from the diverter valve 200 into the die hole 340. Alternatively, an adapter (not shown) can be attached to diverter valve outlet 206 which is accordingly tapered as described herein to accommodate the nose cone 322.

The diverter valve outlet 206 and alternative adapter (not shown), nose cone 322, and die body 324 in FIGS. 7, 11, and 13 as well as the removable insert 350, FIG. 9, heated removable insert 360, FIG. 10, tapered removable insert 382 and die base 388, FIG. 12, can be made of carbon steel, thermally hardened carbon steel, stainless steel including martensitic and austenitic grades, thermally hardened and precipitation-hardened stainless steel, or nickel to improve resistance to abrasion, erosion, corrosion, and wear. Nitriding, carbonitriding, electrolytic plating and electroless plating techniques are for enhancement of these resistance properties are included herein by way of reference.

To provide a smooth surface for die holes 340 in FIGS. 7, 9, 11, 12, and 13 thusly reducing erratics from manufacturing processes including bore marks, conventional technology for the die holes 340 can include treatment by electron discharge machining (EDM) utilizing a wire that is circumferentially rotated about the die hole subsequently enhancing surface smoothness, improving uniformity of the die hole geometry, and controllably and uniformly increasing the die hole diameter. Alternatively, high-velocity abrasive and polishing grits of uniformly fine grain size can be passed through the die holes to effect improved smoothness within the die hole. Additionally, inserts to reduce abrasion and adhesion can be placed into the lands of die holes 340. Fluoropolymer, ceramic, and tungsten carbide inserts are non-limiting examples. Other surface treatments for improvement of surface properties, enhancement of corrosion and abrasion resistance, and improvement of wear can be used without intending to be limited.

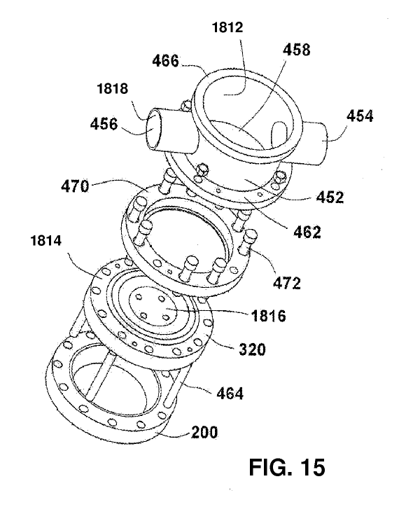

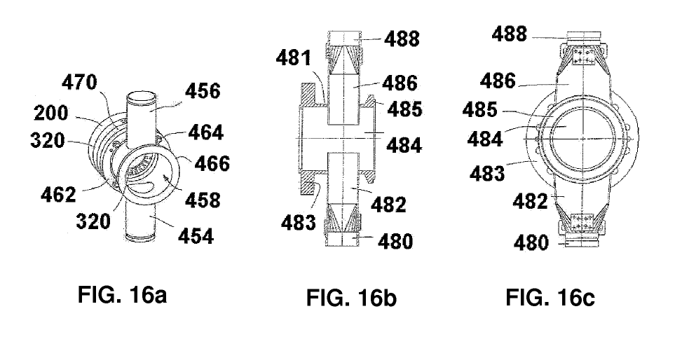

Referring once again to FIG. 3, the die 320 is fixedly attached to cutting shroud 400 as shown in FIGS. 7 and 13 and detailed in FIGS. 15, and 16a, b, c. FIG. 13 illustrates a configuration of a one-piece cutting shroud 400 that comprises a housing 402 to which is connected inlet pipe 404 and outlet pipe 406 of similar diameter and geometry and diametrically opposed positionally and interconnectedly attached to a rectangular, square, or preferably cylindrical or other geometrically open cutting chamber 408 surrounding and of sufficient diameter to completely encompass the die face 410 (representationally equivalent to the surface of hardface 370 in FIGS. 7, 9, 10, 11, 12, and 13). Housing 402 has mounting flange 412 through which a plurality of mounting bolts 414 pass to sealingly attach the cutting shroud 400 and die 320 to diverter valve 200. Flange 416 on housing 402 allows attachment to the pelletizer 900 (see FIG. 3) as is detailed below. Components that are free to rotate within the cutting chamber 408 are described hereinafter.

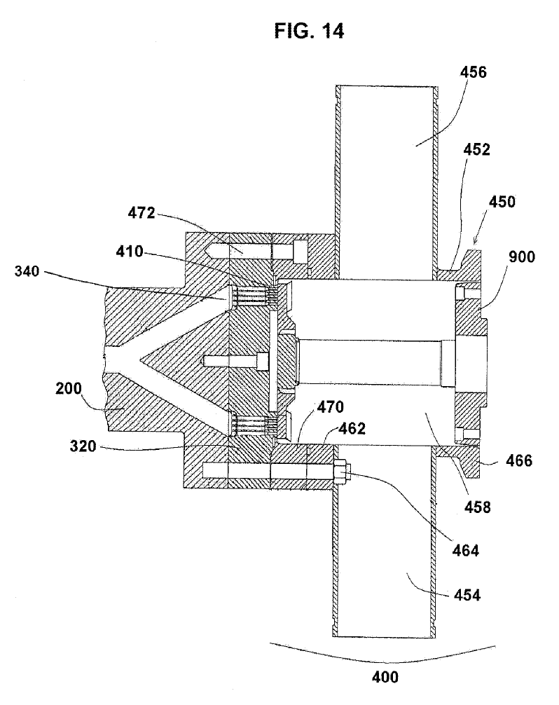

Similarly, FIG. 14 illustrates a two-piece configuration of cutter shroud 400 comprising a main body 450 with housing 452 to which is connected inlet pipe 454 and outlet pipe 456 of similar diameter and geometry and diametrically opposed positionally and interconnectedly attached to a rectangular, square, or preferably cylindrical or other geometrically open cutting chamber 458 surrounding, and of sufficient diameter to completely encompass, the die face 410 (representationally equivalent to the surface of hardface 370 in FIGS. 7, 9, 10, 11, and 12) comparably described above and as completely assembled as herein described. Housing 452 has mounting flange 462 through which a plurality of mounting bolts or studs 464 pass. Mounting flange 462 sealingly attaches to adapter ring 470 of comparable diameter, both inside and outside dimensions, through which pass a plurality of countersink bolts 472. Mounting bolts or studs 464 and countersink bolts 472 are preferably alternating positionally and sealingly attach the components of and thus the complete cutting shroud 400 and die 320 to diverter valve 200. Flange 466 on housing 452 of the main body 450 allows attachment to the pelletizer 900 (see FIG. 3) as is detailed below. Components that are free to rotate within the cutting chamber 408 in FIG. 13 and/or cutting chamber 458 in FIG. 14 are described hereinafter. Separate attachment of the adapter ring 470 to and through the die 320 allows the main body 450 to be removed for cleaning or maintenance while leaving die body 320 sealingly attached to diverter valve 200.

An exploded view of the two-piece configuration of cutting shroud 400 is illustrated in FIG. 15 with a complete assembly illustrated in FIG. 14. Reference numbers are retained to be consistent wherein similar parts have similar numbers in FIGS. 13, 14, and 16a.

FIGS. 16b and 16c illustrate an alternative design for the cutting shroud inlet and outlet in that inlet 480 is fixedly attached to a rectangular or square inlet tube 482 that taperingly increases along its length as it approaches the housing 481 to which it is attachedly connected and within which is cutting chamber 484. Similarly attached to housing 481 and diametrically opposed to inlet tube 482 is rectangular or square outlet tube 486 that taperingly decreases along its length to outlet 488 to which it is fixedly attached. Flange 483 and flange 485 in FIGS. 16b and 16c compare in design and purpose to flanges 462 and 466 in FIG. 16a previously described.

FIGS. 16a, b, and c illustrate a preferred diametrically opposed inlets and outlets. Alternatively, the inlets, 454 and 480, and outlets, 456 and 488, can be located at an angle from approximately 20° to a preferred 180° relative to and defined by the position of outlet to inlet and can be opposingly or staggeringly attached to housing 481 by way of example. Dimensions of the inlet and outlet can be the same or different and the inlet and outlet can be similar or different in design. Preferably the inlet and outlet so identified are of similar dimension and design, and are diametrically opposed.

Returning to FIG. 15, for conventional surface treatments to reduce abrasion, erosion, corrosion, wear, and undesirable adhesion and sticture, the inner surface 1812 of flange 466 and the lumens 1818 of inlet pipe 454 and outlet pipe 456 (lumen not shown) can be nitrided, carbonitrided, sintered, can undergo high velocity air and fuel modified thermal treatments, and can be electrolytically plated. The exterior surface 1814 and exposed surface 1816 of die body 320 can be treated similarly. It is understood that variations illustrated in FIGS. 7, 9, 10, 11, 12, 13, 14, and 16a, b, c can be treated similarly. Other surface treatments for improvement of surface properties, enhancement of corrosion and abrasion resistance, improvement of wear, and/or reduction of clumping, agglomeration, and/or sticture can be used without intending to be limited.

Cutting shroud 400 as illustrated in FIGS. 13, 14, 15, and 16a, b, c generically exemplifies fluid flow into inlet pipes 404, 454, and 482 with flow through cutting chambers 408, 458, and 484 respectively. Effluent flow from the respective cutting chambers exits through respective outlet pipes 406, 456, and 486. In an alternative application, fluid flow is not utilized and pellets generated in processes hereinafter described, freely fall from cutting chambers 408, 458, and 484 out of (inlet) pipes 404, 454, and 482 respectively. Optionally, air or other inert gas or fluid spray or mist can be introduced into and through respective (outlet) pipes 406, 456, and 486 to assist in purging the pellets from the respective cutting chambers. The (outlet) pipes optionally can be covered, not shown, to which and through which an inlet nozzle, also not shown, can be fixedly attached through which the aforementioned air, inert gas, or fluid spray or mist can be introduced. Mechanisms and apparatus for introduction of these expediting media are known conventionally to those skilled in the art.

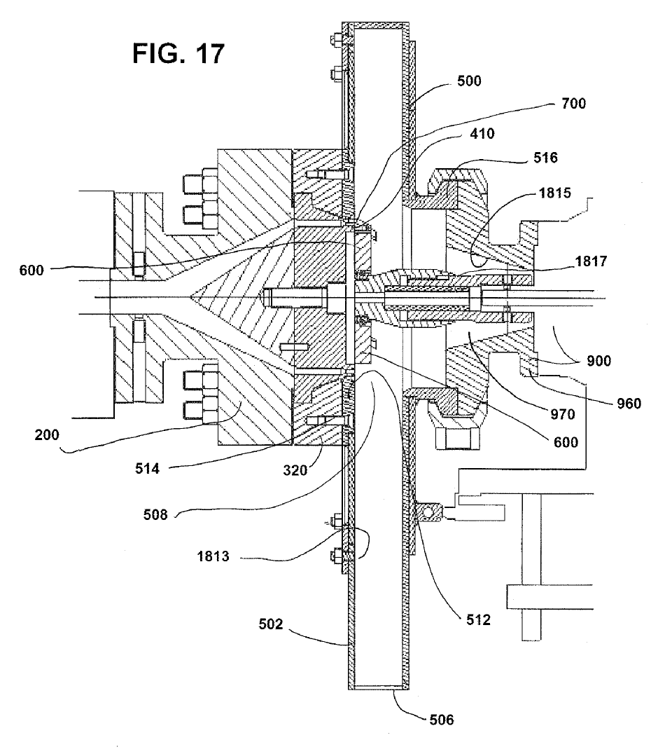

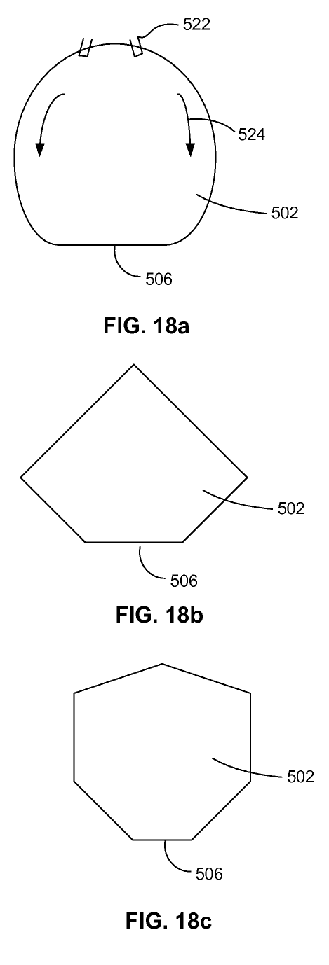

Alternatively, non-fluid cutting shroud 500, illustrated in FIG. 17, comprises a housing 502 of single-body construction and enclosing cutting chamber 508 surrounding and of sufficient diameter to completely encompass the die face 410 (representationally equivalent to the surface of hardface 370 in FIGS. 7, 9, 10, 11, 12, and 13). Housing 502 has mounting flange 512 through which a plurality of mounting bolts 514 pass to sealingly attach the non-fluid cutting shroud 500 and die 320 to diverter valve 200. Flange 516 on housing 502 allows attachment to the pelletizer 900 (see FIG. 3) as is detailed below. Components that are free to rotate within the cutting chamber 508 are described hereinafter. Pellets generated in cutting chamber 508 by processes described hereinbelow fall freely through pellet outlet 506. Housing 502 generally can be oval to round as in FIG. 18a, rectangular to square as in FIG. 18b, hexagonal to polygonal as in FIG. 18c, and many geometries without intending to be limiting, such that housing 502 tapers toward the lowest most position to form pellet outlet 506 in all respective FIGS. 18a, b, and c. At least one, and preferably two or more, and more preferably a multiplicity of optional inlet nozzles 522, FIG. 18a, are attachedly connected to housing 502 at many angles including a range from perpendicular to tangential relative to the housing at the point of attachment and are preferably attached tangentially at an angle comparable to the radius of the curve formed by the housing. Attachment of the inlet nozzles 522 can be at a multiplicity of points circumferentially around housing 502 and are preferably attached at least at the uppermost point of housing 502. The inlet nozzles 522 can be oriented to direct the flow of at least one of air, inert gas, and/or fluid, wherein the fluid is in the form of a vapor, mist, and/or thin stream, about the periphery of the housing 502. More preferably, the flow is directed circumferentially about the periphery of housing 502 as illustrated by directional arrows 524 to facilitate flow of the pellets to and through the cutting chamber 508, FIG. 17, thusly to and through outlet 506.

Optionally, inlet nozzles 522 can be replaced with blowers to expedite air or inert gas flow into and through cutting chamber 508. Additionally, housing 502 can be jacketed for thermal regulation. The jacketing can fully enclose housing 502 for circulation of thermal transfer fluids, heating or cooling for example, and alternatively can surround a perforated housing 502 to allow through flow of air and other inert gases into the cutting chamber 508. The multiplicity of air, inert gas, and fluid sprays, mists, and the like, herein described facilitate pellet flow through the cutting chamber and provided additional thermal regulation, preferably cooling, and solidification of the pellets being produced.

The housing 502 can be of any material including but not limited to plastic, tool steel, hardened steel, stainless steel, and nickel steel. The weldments and joints can be filleted, contoured, rounded, beveled and the like. The outlet 506 can be of many dimensions that permit free flow of the pellets thusly formed through the opening without blockage, obstruction, and occlusion.

The inside surface 1813 of housing 502 can be coated with conventional surface treatments to reduce abrasion, erosion, corrosion, wear, and undersirable adhesion and sticture. Metal components of the housing 502 can be nitrided, carbonitrided, sintered, can undergo high velocity air and fuel modified thermal treatments, and can be electrolytically plated. Other surface treatments and many combinations of surface treatments for improvement of surface properties can be used without intending to be limited.

Once again returning to the principle disclosure illustration in FIG. 3, pelletizer 900 is shown in the non-operational open position. Attached to the pelletizer is optional flow guide 800, and cutter hub 600 with cutter blades 700. Upon operation of the equipment, pelletizer 900 is moved into position such that it can be fixedly attached to flange 416 of the one-piece configuration of cutting shroud 400 or flange 466 on the main body 450 of the two-piece configuration of cutting shroud 400 as detailed in FIGS. 13 and 14, respectively. Attachment is most preferably made, but not limited to, quick disconnects but can be through many mechanisms. In the operating configuration, the cutter hub 600 and cutter blades 700 freely rotate within the cutting chamber 408 (FIG. 13) or 458 (FIG. 14). Details of all illustrated components are contained within the ensuing discussions.

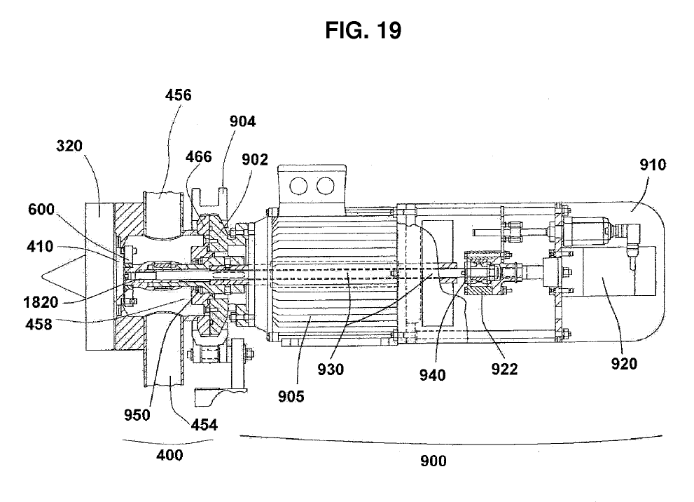

The pelletizer 900 of the instant invention is shown diagramatically in FIG. 19 and can be positionally adjustable in terms of cutter hub 600 relationally to die face 410. FIG. 19 represents the pelletizer 900 in operational position wherein it is sealingly attached via pelletizer flange 902 to cutting shroud flange 466 tightly held by removable quick disconnect clamp 904, for example. Positional adjustment of the pelletizer can be achieved manually, spring-loaded, hydraulically, pneumatically, or electromechanically, or can be achieved by combinations of these mechanisms acting cumulatively in one direction or opposingly in counter-direction of forces applied to insure appropriateness of position as necessitated to achieve even wear, increased longevity, avoidance of undue extrusion leading to melt wrap around the cutter hub or the die face 410, and consistency of the pelletized product. A preferred design is of the hydraulic-pneumatic mechanism detailed in FIG. 19 comprising a motor 905, housing 910, and containing hydraulic cylinder 920 engagedly attached to coupling 922. A rotor shaft 930 connects coupling 922 to the cutter hub 600 at the die face 410 and passes through thrust bearing 940 and sealing mechanism and preferably a mechanical sealing mechanism 950 in fluid contact with cutting chamber 458 of cutting shroud 400. Inlet pipe 454 and outlet pipe 456 indicate flow direction of fluids into the cutting chamber 458, admixture of fluids and pellets in the cutting chamber 458, and subsequently, flow of the pellet slurry formed away from the cutter hub 600 as well as die face 410 and out of the cutting chamber 458.

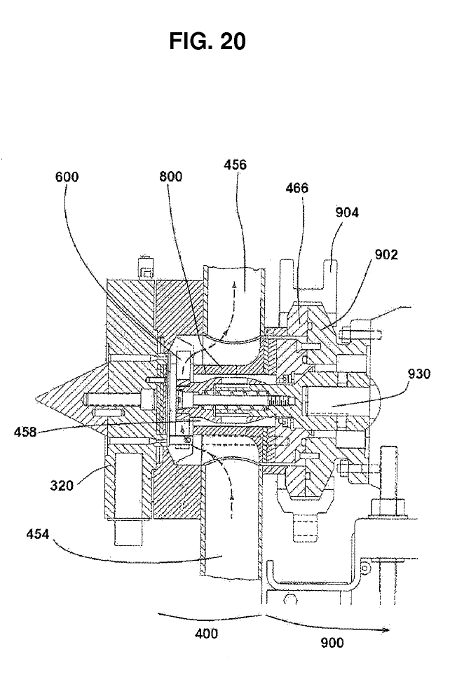

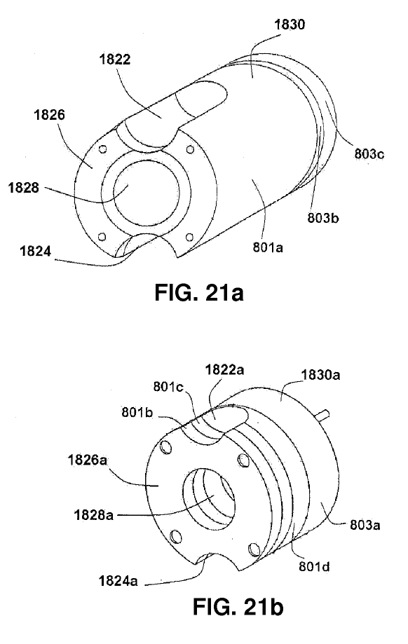

To increase fluid velocity through the cutting chamber 458, improve pellet quality, reduce freeze off, avoid wrapping of melt around die face 410, generate or increase head pressure, and improve pellet geometry, FIG. 20 illustrates a preferred configuration in which flow guide 800 is positioned in the cutting chamber 458 effectively reducing the fluid volume of that region. The die 320, cutting shroud 400, and pelletizer 900, shown only partially, are positionally the same as in FIG. 19. The hollow shaft rotor preferably is attached to cutter hub 600 in cutting chamber 458 with appropriate inlet pipe 454 and outlet pipe 456 as previously described. The pelletizer 900 is sealingly and removably attached to the cutting shroud 400 through use of quick disconnect clamp 904 on pelletizer flange 902 and cutting shroud flange 466 as before. FIGS. 21a and 21b show two exemplary configurations for flow guide 800, in which sections can be of similar or different segmental length having consistent outside diameter that is less than the diameter of cutting chamber 458 and can be varied in accordance with the requisite diminution of volume desired in that cutting chamber 458. Flow guide spacer sections 803 can be uniform circumferentially and diametrically as indicated singly by 803a, or plurally in 803b and 803c, but can vary in segmental length and are not limited in plurality to two as shown. To direct and/or restrict flow, flow directing segments 801 singly in 801a or unlimited plurally in 801b, 801c, and 801d, for example, are modified by longitudinally extending grooves that are arcuate in transverse configuration with the deepest grooved section positioned proximal to the cutter hub 600. A preferred configuration of a series of segments is not intended to be limited as to number of segments and a single flow guide component of comparable geometry and functionality is well within the scope of the present invention.

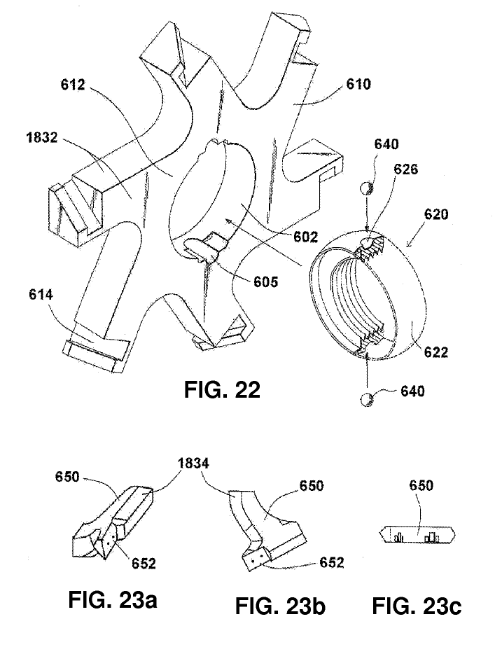

Continuing with FIG. 19, cutter hub 600 is attached by screwing onto the threaded end of the rotor shaft 930 of pelletizer 900. The cutter hub 600 can be rigidly mounted to the rotor shaft 930 and can contain a number of cutter arms 610 in balanced proportion placed circumferentially about the cutter hub 600 as illustrated in FIG. 22. Alternatively and preferably, the cutter hub 600 is flexibly attached to rotor shaft 930 using an adapter 620 in which the adapter 620 is attachedly and threadedly connected to rotor shaft 930. Adapter 620 has a partial spherical outer surface 622 matching a similar partial spherical inner surface bore 602 in the cutter hub 600. Diametrically opposed and recessed into the partial spherical inner surface bore 602 are longitudinal recesses 605 that extend to the edge of the cutter hub 600 and into that fit ball 640. Similarly, diametrical recesses 626 for ball 640 are located on adapter 620 positionally oriented such that longitudinal recess 605 and diametrical recess 626 align to interlockingly affix balls 640 once adapter 620 is inserted orthogonally into position and rotated to a position parallel to cutter hub 600. This allows free oscillation of the cutter hub 600 about the diametrically positioned balls 640 on fixedly attached adapter 620 to rotor shaft 930 that permits rotational self-alignment of the cutter hub 600.

The cutter arms 610 and body of cutter hub 612 can be square or preferably rectangular in cross-section as shown in FIG. 22 or can be more streamlined to give an extended hexagonal cross-section as illustrated in FIG. 23c. FIGS. 23a and 23b shows segments of streamline cutter hub 650. Cutter blades (not shown) are fixedly attached by screw or similar mechanism at flattened angular groove 614, FIG. 22, or at flattened angular notch 652, FIGS. 23a and 23b.

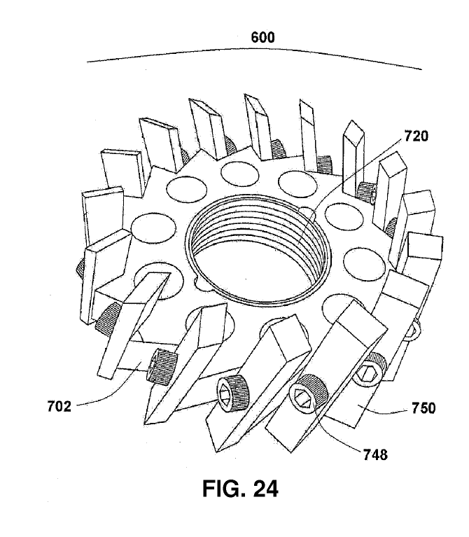

Alternatively, FIG. 24 illustrates a preferred steep-angle cutter hub 600, in which cutter arms 610 as shown in FIG. 22 are optionally replaced by cutter blade support 702 to which are attached cutter blade 750 preferably by screw 748 while other mechanisms are known to those skilled in the art and are not limited as herein described. Adapter 720 allows self-aligning flexibility with threaded attachment to rotor shaft 930, FIG. 19, as detailed previously. Other cutter hub designs that are functionally equivalent are within the scope of the present invention as are known to those skilled in the art.

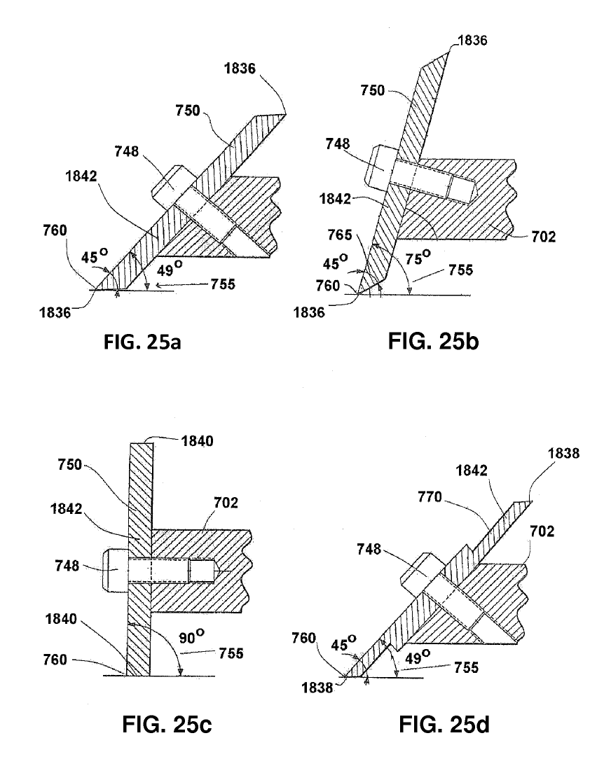

FIGS. 25a, b, c, and d illustrate various angularly inclined positions and shapes of the cutter blades 750 including half-thickness blade 770. The blade angle 755 can vary from approximately 0° to approximately 110° or greater, FIGS. 25a, b, and c, relative to die hard face 370, FIGS. 7, 9, 10, 11, 12, and 13, with a blade angle 755 of between approximately 60° to approximately 79° preferred, FIG. 25b, and a blade angle of approximately 75° more preferred. The blade cutting edge 760 can be square, beveled, or angled as has been demonstrated by prior art and is preferably at a blade cutting angle 765 of approximately 20° to approximately 50° and more preferred at approximately 45°. Alternatively, and most preferred, is a half-thickness blade 770 as illustrated in FIG. 25d that can be similarly attached, similarly angled, and with comparable blade cutting angles and preferences as described above. Additionally, blade designs, dimensionally and compositionally, can prove useful depending on other process parameters.

The cutter blade 750 and half-thickness blade 770 compositionally include, but are not limited to, tool steel, stainless steel, nickel and nickel alloys, metal-ceramic composites, ceramics, metal or metal carbide composites, carbides, vanadium hardened steel, suitably hardened plastic, or other comparably durable material and can be further annealed and hardened as is well known to those skilled in the art. Wear-resistance, corrosion resistance, durability, wear lifetime, chemical resistance, and abrasion resistance are some of the important concepts influencing the utility of a particular blade relative to the formulation being pelletized. Blade dimensions of length, width, and thickness as well as number of blades used relationally with cutter hub design are not limited within the scope of the present invention.

Returning to FIG. 19, conventional surface treatments to reduce abrasion, erosion, corrosion, wear, and undesirable adhesion and sticture, can be applied to the outer surface 1820 of the exposed portion of the rotor shaft 930 that extends out from the cutting shroud flange 466 into cutting chamber 458 and can be nitrided, carbonitrided, metallized by sintering, and electrolytically plated. The extent of the surface treatment on rotor shaft 930 is reduced to the portion distal from cutting shroud flange 466 when flow guide 800 is utilized to reduce the volume of the cutting chamber 458 as heretofore described.

Similarly, conventional nitriding, carbonitriding, sintering, high velocity air and fuel modified thermal treatments, and electrolytic plating can also be applied to the surfaces of flow guide 800 (FIG. 20) as detailed in FIGS. 21a and 21b. In particular, the outlet flow surfaces 1822 and 1822a, the inlet flow surfaces 1824 and 1824a, flow guide faces 1826 and 1826a distal from flange 466 and flow guide faces (not shown) proximal to flange 466, the flow guide lumen surfaces 1828 and 1828a, and the flow guide circumferential surface 1830 and 1830a. These same conventional treatments can be applied to the cutter hub and arm surfaces 1832 of cutter hub 612 and cutter arms 610 detailed in FIG. 22 and to cutter hub and arm surfaces 1834 of variant design cutter hub and cutter arms illustrated in FIGS. 23a and 23b. Cutter blade 750 and half-thickness blade 770 illustrated in FIGS. 25a, b, c, d may be similarly treated on the tip surface 1836 in FIGS. 25a and 25b, on tip surface 1838 in FIG. 25d, and edge surface 1840 in FIG. 25c. Alternatively, circumferential blade surface 1842 can optionally be treated conventionally as well. Other surface treatments for improvement of surface properties, enhancement of corrosion and abrasion resistance, improvement of wear, and/or reduction of clumping, agglomeration, and/or sticture can be used without intending to be limited.

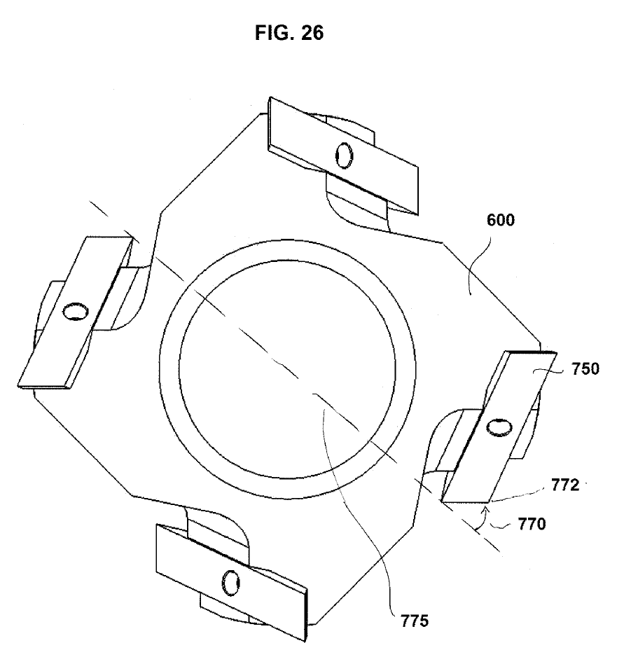

Returning to FIG. 17 for the non-fluid cutting chamber 500, the pelletizer 900 and cutter hub 600 with cutter blades 700 in the operating configuration, allows the cutter hub 600 and cutter blades 700 to freely rotate within the cutting chamber 508. The housing 502 is fixedly mounted as heretofore described such that it uniformly aligns with die face 410 allowing the periphery of cutter hub 600 to be unobstructedly open to the outward movement of the pellets being cut. Consequently prior art cutter hubs 600 as illustrated in FIG. 26 wherein the cutting angle 770 relative to cutter hub centerline 775 and distal tip 772 of blade 750 can vary from approximately 0° to approximately 60° or greater, preferably from approximately 25° to approximately 55°, and more preferably from approximately 40° to approximately 55° facilitating removal of the pellets from the die face 410. It is understood that all variants illustrated in FIGS. 22, 23a, b, and c, 24, and 25a, b, c, and d are anticipated in the design of cutter hub 600 illustrated in FIG. 26.

Additionally, the non-fluid cutting shroud 500 illustrated in FIG. 17 does not require fluid flow for pelletization thus allowing the removal of fluid-lubricated mechanical sealing mechanism previously disclosed for pelletizer 900 (reference number 950 in FIG. 19) to be removed. Pelletizer flange 960 contains cavity 970 that can be of many designs to reduce or eliminate pellet build-up including cylindrical, polygonal, and tapering, and is preferably tapered conically decreasing distal to and continuous with the cutting chamber 508. Conventional surface treatments to reduce abrasion, erosion, corrosion, wear, and undesirable adhesion and sticture can be applied to the inner surface 1815 of cavity 970 and exposed surface of pelletizer shaft 1817. These surface treatments can be at least one of nitriding, carbonitriding, sintering, can undergo high velocity air and fuel modified thermal treatments, and can be electrolytically plated. Other surface treatments and many combinations of surface treatments for improvement of surface properties can be used as are known by those skilled in the art without intending to be limited.

Returning to FIG. 1, the cutting shroud 400 or non-fluid cutting shroud 500, pelletizer 900, cutter hub 600, cutter blades 700, and optional flow guide 800 are components of pelletizing section 3 further illustrated by way of example as detailed in FIG. 3. Pelletization can result in pellets 4a as a consequence of “dry” pelletizing processes through non-fluid cutting shroud 500 as well as through cutting shroud 400 wherein fluid is not used to form a pellet slurry allowing the pellets to fall freely from the cutting shrouds. Alternatively, a pellet slurry 4b is formed in cutting shroud 400 when fluid is introduced through inlet pipe 404, FIG. 13, through inlet pipe 454, FIGS. 14, 15, and 16a, as well as through inlet 480, FIGS. 16b and c.

Pellets 4a, FIG. 1, can be finished pellets 11 as produced. Alternatively, they can undergo at least one pellet manipulation 5 that produces finished pellets 11 or combines the pellet with fluid to make a pellet slurry that can undergo a first slurry manipulation 6. Pellet manipulation 5 can include at least one of cooling, warming, defluidizing, conditioning, particulate coating, fluidic coating, intrapellet reaction, surface modification, and slurry formation.

Similarly, pellet slurry 4b in FIG. 1 or the pellet slurry formed as one possible consequence of pellet manipulation 5 can undergo a first slurry manipulation 6. This first slurry manipulation 6 can include at least one of cooling, warming, dewatering, chemical modification, defluidizing, conditioning, particulate coating, reactive coating, fluidic coating, intrapellet reaction, extraction, impregnation, and surface modification. First slurry manipulation 6 can be followed by optional second slurry manipulation 7 that can include at least one of cooling, warming, dewatering, chemical modification, defluidizing, conditioning, particulate coating, reactive coating, fluidic coating, intrapellet reaction, extraction, impregnation, surface modification, and second slurry formation. Optional second slurry manipulation 7 can be followed by at least one optional third slurry manipulation 8 comparable in variance to second slurry manipulation 7 such that intermediate pellet 9 or finished pellet slurry 12 is produced. Intermediate pellet 9 can be finished pellets 11 as produced or can undergo intermediate pellet manipulation 10 to form finished pellets 11. Intermediate pellet manipulation 10 can include at least one of cooling, warming, defluidizing, conditioning, particulate coating, fluidic coating, intrapellet reaction, and surface modification ultimately leading to the formation of finished pellet 11. Additionally, finished pellets 11 and finished pellet slurry 12 can undergo optional post-processing manipulations 99. Each process and manipulation is discussed hereinbelow. Solid pellet manipulations following pellets 4a and pellet manipulation 5 will be discussed with comparable manipulations for intermediate pellet manipulation 10.

By way of example, the apparatus for a multiplicity of processes is illustrated hereinbelow wherein the pellet slurry 4b is transported to a fluid removal and defluidizing unit (slurry manipulation 6 comparing standard bypass transport and expedited conditioning transport) after which it is reslurried and carried to a pellet conditioning system (slurry manipulation 7 for slow conditioning) followed by a second fluid removal and defluidizing step (slurry manipulation 8) to form intermediate pellets 9. Apparatus for two intermediate pellet manipulations 10 are detailed in which the pellets are solid coated or alternatively, are further conditioned by retention in a vibratory weir system to generate finished pellets 11.

FIG. 3 illustrates the process by which pelletization is done via fluid flow into and through cutting shroud 400 with subsequent transport of the pellet slurry 4b produced into the bypass loop 550. A transport fluid for use in the bypass loop 550 and pellet transportation, is obtained from reservoir 1600 or other sources, and is transported toward the cutting shroud 400 through pump 520 that can be of a design and/or configuration to provide sufficient fluid flow into and through the optional heat exchanger 530 and transport pipe 535 to and into bypass loop 550. The heat exchanger 530 similarly can be of a design of suitable capacity to maintain the temperature of the transport fluid at a temperature appropriately suitable to maintain the temperature of the pellets being formed such that pellet geometry, throughput, and pellet quality are satisfactory without tailing, and where wrap-around of molten material on the cutting face, agglomeration of pellets, cavitation, and/or accumulation of pellets in the cutting shroud 400 are maximally avoided. Temperatures and flow rates as well as composition of the transport fluid will vary with the material or formulation being processed. Transport medium/fluid temperatures are preferably maintained at least approximately 20° C. below the melting temperature of the material and preferably are maintained at a temperature of between approximately 30° C. to approximately 100° C. below the melt temperature. Maintenance of the transport fluid temperature is more preferably maintained at least approximately 5° C. below its boiling point, still more preferred approximately 10° C. below its boiling point. Similarly, the transport fluid temperature is preferably maintained at least approximately 5° C. above its melting temperature and more preferably is at least 10° C. above its melting temperature. Additionally, transport fluid temperature is maintained below its flash point and is preferably maintained at least approximately 30° C. below its flash point. Preferably, transport fluids are maintained under a positive flow of inert gas and more preferably under a positive flow of nitrogen or argon.

Piping, valving, and bypass components should be of suitable construction to withstand the temperature, chemical composition, abrasivity, corrosivity, and/or any pressure requisite to the proper transport of the pellet-transport fluid mixture. Any pressure required by the system is determined by the transport distance, vertical and horizontal, pressure level needed to suppress unwanted volatilization of components or premature expansion, pellet-transport fluid slurry flow through valving, coarse screening, and ancillary process and/or monitoring equipment. Pellet-to-transport fluid ratios should similarly be of varying proportions to be satisfactorily effective in eliminating or alleviating the above-mentioned complicating circumstances exemplary of which are pellet accumulation, flow blockage or obstruction, and agglomeration. Piping diameter and distances required are determined by the material throughput, thus the flow rate and pellet-to-transport fluid ratio, and time required to achieve an appropriate level of cooling and/or solidification of the pellets to avoid undesirable volatilization and/or premature expansion. Valving, gauges, or other processing and monitoring equipment should be of sufficient flow and pressure rating as well as of sufficient throughpass diameter to avoid undue blockage, obstruction or otherwise alter the process leading to additional and undesirable pressure generation or process occlusion.

Pump 520 and heat exchanger 530 in FIG. 3 are prone to abrasion, erosion, corrosion, and wear as well particularly from by-products of the pelletization process, and components (not shown) can optionally be surface treated utilizing conventional nitriding, carbonitriding, sintering, high velocity air and fuel modified thermal treatments, and electrolytic plating. In addition, flame spray, thermal spray, plasma treatment, electroless nickel dispersion treatments, and electrolytic plasma treatments, singly and in combinations thereof can be utilized as is known to those skilled in the art.

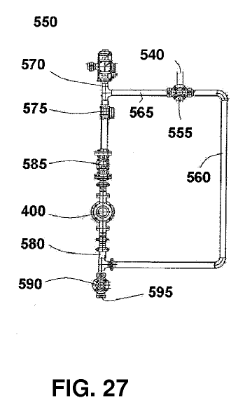

The standard bypass loop 550, as illustrated in FIG. 27, allows the transport fluid, preferably water, from inlet pipe 540 to enter three-way valve 555 and be redirected into the bypass flow or toward the cutting shroud 400. To bypass the cutting shroud 400, the transport fluid is directed by three-way valve 555 into and through bypass pipe 565 into outlet pipe 570. To achieve this, blocking valve 575 is closed. Alternatively, to allow transport fluid to flow to and through the cutting shroud 400 the three-way valve 555 is directed to allow flow into and through pipe 560 and into pipe 580 with blocking valve 575 open and with drain valve 590 closed. Transport fluid proceeds into and through cutting shroud 400 and transports pellets into and through sight glass 585 through blocking valve 575 and into outlet pipe 570 for down-stream processing as described below. To drain the system and allow cleaning or maintenance of the cutting shroud 400 or die hardface 370 or to replace any of the die 320 components (FIGS. 7, 13, and 14, for example), three-way valve 555 directs flow into and through pipe 565 and into outlet pipe 570. With blocking valve 575 now closed and drain valve 590 open, the transport fluid remaining entrapped below 575, in components 585, 400, 560, and 580 drains out drain 595 for recycling or disposal.

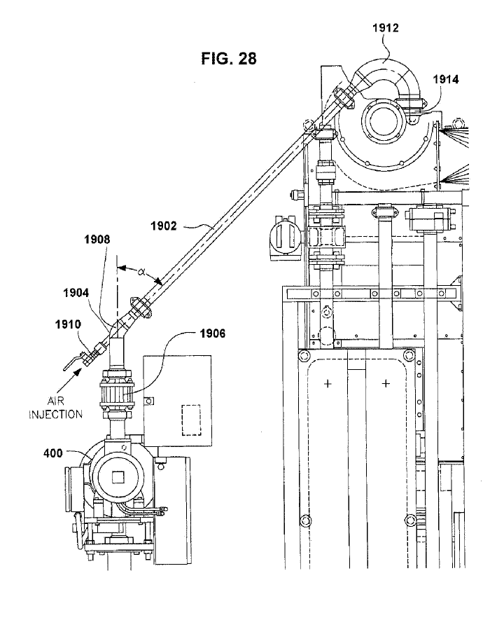

Once the pellet is sufficiently solidified for processing, it is transported via pipe 1270 to and through an agglomerate catcher/fluid removal unit 1300 and into the defluidizing unit 1400, subsequently exiting the dryer for additional processing as described hereunder.

Wherein conditioning of the pellets is a part of the process, the standard bypass loop 550 is optionally replaced with a direct pathway between the cutting shroud 400 and the dryer 1400 such that pressurized air can be injected into that pathway as illustrated in FIG. 28. Air, or other inert gas, is injected into the system slurry line 1902 at point 1904, preferably adjacent to the exit from the cutting shroud 400 and near the beginning of the slurry line 1902. This preferred site 1904 for air injection facilitates the transport of the pellets by increasing the transport rate and facilitating the aspiration of the transport fluid in the slurry, thus allowing the pellets and granules to retain sufficient latent heat to effect the desired conditioning. High velocity air is conveniently and economically injected into the slurry line 1902 at point 1904 using conventional compressed air lines typically available at manufacturing facilities, such as with a pneumatic compressor. Other inert gas including, but not limited to, nitrogen or argon can be used to convey the pellets at a high velocity as described. This high velocity air or inert gas flow is achieved using the compressed gas producing a volume of flow of at least approximately 100 cubic meters/hour using a standard ball valve for regulation of a pressure of at least approximately 8 bar into the slurry line which is standard pipe diameter, preferably approximately 1.6 inch (approximately 4.1 centimeters) pipe diameter.

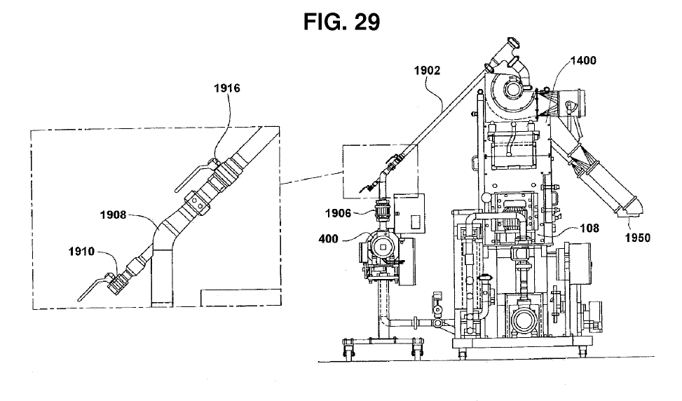

To those skilled in the art, flow rates and pipe diameters can vary according to the throughput volume, level of crystallinity desired, and the size of the pellets and granules. The high velocity air or inert gas effectively contacts the pellet slurry generating vapor by aspiration, and disperses the pellets throughout the slurry line propagating those pellets at increased velocity into the dryer 1400, preferably at a rate of less than one second from the cutting shroud 400 to the dryer exit 1950 (FIG. 29). The high velocity aspiration produces a mixture of pellets in an air/gas mixture that may approach approximately 98-99% by volume of air in the gaseous mixture.

FIG. 28 illustrates air injection into the slurry line 1902. The pellet slurry exits the cutting shroud 400 into the slurry line 1902 through the sight glass 1906 past the angle elbow 1908 where the compressed air is injected from the air-injection inlet valve 1910 through the angled slurry line 1902 and past the enlarged elbow 1912 through and into dryer 1400. It is preferred that the air injection into the angled elbow 1908 is in line with the axis of the slurry line 1902 providing the maximum effect of that air injection on the pellet/water slurry resulting in constant aspiration of the mixture. The angle formed between the vertical axis of slurry line 1902 and the longitudinal axis of said slurry line 1902 can vary from approximately 0° to approximately 90° or more as obviated by the variance in the height of the pelletizer 900 relative to the height of the dryer inlet 1914 to the dryer 1400. This difference in height can be due to the physical positioning of the dryer inlet 1914 of dryer 1400 in relation to the pelletizer 900 or can be a consequence of the difference in the sizes of the dryer and pelletizer. A preferred angle range is from approximately 30° to approximately 60° with the more preferred angle being approximately 45°. The enlarged elbow 1912 into the dryer inlet 1914 facilitates the transition of the high velocity aspirated pellet slurry from the incoming slurry line 1902 into the dryer inlet 1914 and reduces the velocity of the pellet slurry into the dryer 1400. The position of the equipment, as shown in FIG. 29, allows transport of the pellets from the pelletizer 900 to the dryer exit 1950 in approximately one second which minimizes loss of heat inside the pellet. This is further optimized by insertion of a second valve mechanism, or more preferred a second ball valve 1916, after the air-injection inlet valve 1910. This additional ball valve allows better regulation of the residence time of the pellets in the slurry line 1902 and reduces vibration that can occur in the slurry line. The second ball valve 1916 can allow additional pressurization of the air injected into the chamber and can improve the aspiration of the water from the pellet/water slurry. This can become especially important as the size of the pellets and granules decrease in size.

Abrasion, erosion, corrosion, wear, and undesirable adhesion and sticture can be problematic in transport piping as illustrated FIG. 3 for pipe 1270, in FIG. 27 for bypass loop 550 piping exemplarily including pipes 540, 560, and 565, as well as slurry line 1902 in FIG. 28. These pipes can be manufactured to form short radius and long radius right angles or alternatively can be bent to form short radius and long radius sweep angles or curves. Without intending to be bound by theory, it is anticipated that induced stresses can be introduced by such manipulations potentially leading to increased likelihood of wear-related failures due to abrasion, erosion, and/or corrosion, for example. Treatments including nitriding, carbonitriding, sintering, electrolytic plating, electroless plating, thermal hardening, plasma treatments, extrusion, rotational molding or “rotolining”, slush molding, and combinations thereof can be utilized to improve the resistance to wear-related processes and to reduce adhesion and sticture. Other surface treatments for improvement of surface properties, enhancement of corrosion and abrasion resistance, improvement of wear, and/or reduction of clumping, agglomeration, and/or sticture can be used without intending to be limited.

The defluidizing unit or dryer 1400, illustrated in FIG. 3, can be many types of apparatus for achieving a controlled level of moisture for materials that can be flake, globular, spherical, cylindrical, or other geometric shapes. It can be achieved, but is not limited by, filtration, vibratory filtration, centrifugal defluidizing, forced or heated air convection, rotational defluidizing, vacuum defluidizing, or a fluidized bed and is preferred to be a centrifugal dryer, and is most preferred to be a self-cleaning centrifugal dryer 1400.

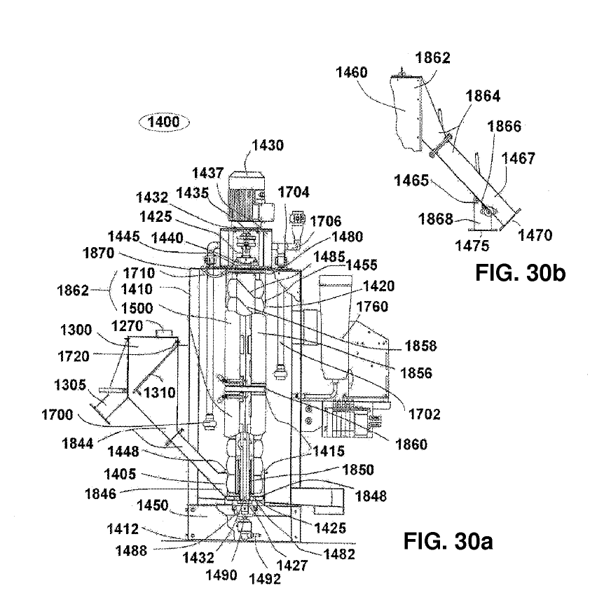

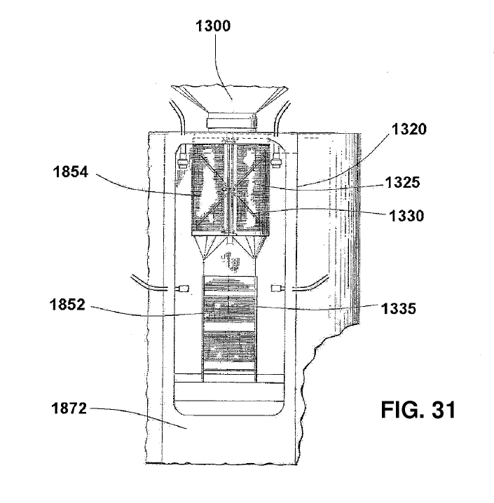

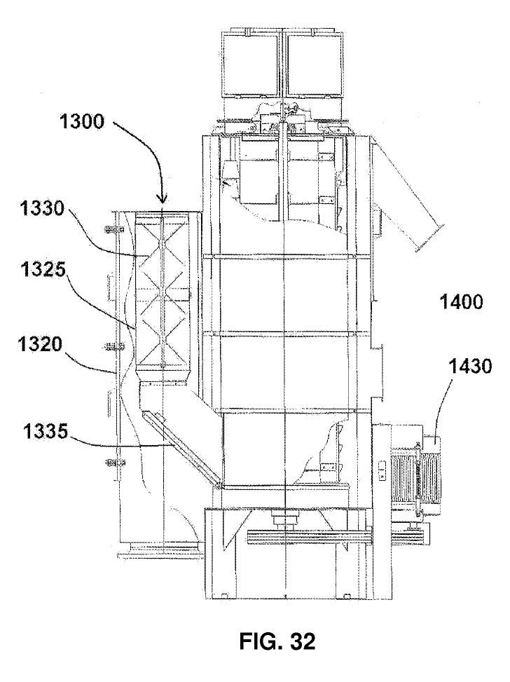

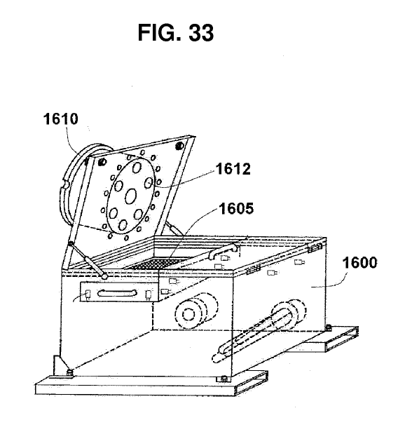

Turning now to FIG. 30a, the pipe 1270 discharges the pellets and fluid slurry or concentrated slurry into an agglomerate catcher 1300 that catches, removes and discharges pellet agglomerates through a discharge chute 1305. The agglomerate catcher 1300 includes an angled round bar grid, perforated plate or screen 1310 that permits passage of fluid and pellets but collects adhered, clumped, or otherwise agglomerated pellets and directs them toward the discharge chute 1305. The pellets and fluid slurry then optionally pass into a fluid removal device 1320, FIG. 31 with additional detail in FIG. 32, that includes at least one vertical or horizontal foraminous membrane screen 1325 containing one or more baffles 1330 and/or an inclined foraminous membrane screen 1335 that enables fluid to pass downwardly into a fines removal screen 1605 and therethrough to the water reservoir 1600 (FIGS. 3 and 33). The pellets that still retain fluid on their surfaces are discharged from fluid removal device 1320 into the lower end of the self-cleaning centrifugal dryer 1400 at a slurry inlet 1405, FIG. 30a.

As illustrated in FIG. 30a, the self-cleaning centrifugal pellet dryer 1400 includes but is not limited to a generally cylindrical housing 1410 having a vertically oriented generally cylindrical screen 1500 mounted on a cylindrical screen support 1415 at the base of the screen, and a cylindrical screen support 1420 at the top of the screen. The screen 1500 is thus positioned concentrically within the housing 1410 in radially spaced relation from the inside wall of the housing.

A vertical rotor 1425 is mounted for rotation within the screen 1500 and is rotatably driven by a motor 1430 that can be mounted at and/or connected to the base of the dryer (FIG. 32) or at the top of the dryer and is preferably mounted atop the upper end of the dryer, FIG. 30a. The motor 1430 is connected to the rotor 1425 by a drive connection 1435 and through a bearing 1440 connected with the upper end of the housing. The connection 1445 and bearing 1440 support the rotor 1425 and guide the rotational movement of the upper end of the rotor. The slurry inlet 1405 is in communication with the lower end of the screen 1500 and rotor 1425 through the lower screen support section 1450 at connection 1448, and the upper end of the housing and rotor is in communication with a dried pellet discharge chute 1460 through a connection, not shown, in the upper screen support section 1455 at the upper end of the housing. A diverter plate 1465 in outlet 1467 can divert dried pellets out of exit 1470 or exit 1475.

The housing 1410 is of sectional construction connected at a flanged coupling, not shown, at a lower end portion of the dryer and a flanged coupling, not illustrated, at the upper end portion of the dryer. The uppermost flange coupling is connected to a top plate 1480 that supports bearing structure 1440 and drive connection 1435 that are enclosed by a housing or guard 1437. A coupling 1432 atop the housing 1437 supports the motor 1430 and maintains all of the components in assembled relation.

The lower end of the housing 1410 is connected to a bottom plate 1412 on top of a water tank or reservoir 1600 by a flange connection 1610 as illustrated in FIG. 33. Apertures 1612 communicate the lower end of the dryer housing with the reservoir 1600 for discharge of fluid from the housing 1410 into the reservoir 1600 as the surface liquid is removed from the pellets. This removal is achieved by action of the rotor that elevates the pellets and imparts centrifugal forces to the pellets so that impact against the interior of the screen 1500 will remove moisture from the pellets with such moisture passing through the screen and ultimately into the reservoir 1600 in a manner well known in the art.

The self-cleaning structure of the disclosed dryer includes a plurality of spray nozzles or spray head assemblies 1702 supported between the interior of the housing 1410 and the exterior of the screen 1500 as illustrated in FIG. 25. The spray nozzle assembly 1702 is supported at the end of spray pipes 1700 extending upwardly through top plate 1480 at the upper end of the housing with the upper ends 1704 of the spray pipes 1700 being exposed. Hoses or lines 1706 feed high pressure fluid, preferably water at a flow rate of at least approximately 40 gallons per minute and hereinafter, gpm, and preferably about 60 gpm to about 80 gpm, and more preferably at approximately 80 gpm or higher to the spray nozzles 1702. The hoses 1706 can optionally feed off a single manifold (not shown) mounted on the dryer 1400.

There are preferably at least three spray head nozzle assemblies 1702 and related spray pipes 1700 and lines 1706. The spray head nozzle assembly 1702 and pipes 1700 are oriented in circumferentially spaced relation peripherally of the screen 1500 and oriented in staggered vertical relation so that pressurized fluid discharged from the spray head nozzles 1702 will contact and clean the screen 1500, inside and out, as well as the interior of the housing 1410. Thus, collected pellets that have accumulated or lodged in hang-up points or areas between the outside surface of the screen 1500 and inside wall of the housing 1410 are flushed through apertures 1612 into the reservoir 1600, FIG. 33. Similarly, leftover pellets inside the screen 1500 and outside the rotor 1425 are flushed out of the dryer and will not contaminate or become mixed with pellets passing through the dryer during a subsequent defluidizing cycle in that a different type pellet is dried.

The region between the screen support section 1450 at the lower end of the dryer and the inner wall of the housing 1410 includes flat areas at the port openings and seams that connect the components of the dryer housing together. The high pressure fluid from the spray head nozzle assembly 1702 effectively rinses this region as well. The base screen support section 1450 is attached to the bottom plate 1412 of the housing 1410 and reservoir 1600 by screws or other fasteners to stationarily secure the housing and screen to the reservoir 1600. The base screen support section 1450 is in the form of a tub or basin as shown in FIG. 30a. Alternatively, in other dryers the base screen support section 1450 can be in the form of an inverted tub or inverted base (not shown).

The rotor 1425 includes a substantially tubular member 1427 provided with inclined rotor blades 1485 thereon for lifting and elevating the pellets and subsequently impacting them against the screen 1500. In other dryers, the rotor 1410 can be square, round, hexagon, octagon or other shape in cross-section. A hollow shaft 1432 extends through the rotor 1425 in concentric spaced relation to the tubular member 1427 forming the rotor. The hollow shaft guides the lower end of the rotor as it extends through an opening 1482 in a guide bushing or bearing 1488 at the lower end of the rotor 1425, as well as aligned openings in bottom plate 1412 and the top wall of the reservoir 1600, respectively. A rotary coupling 1490 is connected to the hollow shaft 1432 and to a source of fluid pressure (not shown), preferably air, through hose or line 1492 to pressurize the interior of the hollow shaft 1432.

The hollow shaft 1432 includes apertures to communicate the shaft 1432 with the interior of the hollow rotor member 1427. These holes introduce the pressurized fluid, preferably air, into the interior of the rotor 1425. The rotor 1425 in turn has apertures in the bottom wall that communicate the bottom end of the rotor 1425 with the interior of the base or tub section 1450 to enable the lower end of the rotor 1425 and the tub section 1450 to be cleaned. Pellets flushed from the rotor and inside screen 1500 are discharged preferentially through the dried pellet outlet chute 1460.

The top of the rotor 1425 inside top section 1455 is also a hang-up point and subjected to high pressure fluid, preferably air, to dislodge accumulated pellets. As shown in FIG. 30a, a nozzle 1710 directs the high pressure air across the top of the rotor 1425 to drive accumulated pellets out of the top section and preferentially into the pellet outlet chute 1460. The nozzle 1710 is fed by an air hose or line, not shown, that extends through top plate 1480 and is connected to a high pressure air source.

In addition to hang-up points or areas occurring in the dryer structure, the agglomerate catcher 1300 can also be cleaned by a separate pipe or hose 1720 controlled by a solenoid valve that directs high pressure fluid onto the pellet contact side of the angled agglomerate grate or catcher plate and bar rod grid 1310 to clean off agglomerates that are then discharged through the discharge tube or chute 1305.

A hose and nozzle supply bursts of air to discharge chute or pipe 1460 in a direction such that it cleans the top of the rotor 1425 and the pellet discharge outlet 1460. The air discharge blows pellets past pipe connections and the diverter plate 1465 in outlet 1467 for discharge of dried pellets out of the dryer.

The rotor 1425 is preferably continuously turning during the full cleaning cycle. Solenoid valves are provided to supply air preferably at about between 60 psi to 80 psi, or more, to additional hang-up points not shown that include the cutting shroud bypass air port, rotor air ports, top section air port, pellet outlet air port and diverter valve air port. The solenoid valves include timers to provide short air bursts, preferably about three seconds, which cleans well and does not require a lot of time. A clean cycle button (not shown) activates the cleaning cycle with the cutting shroud bypass air port being energized first to allow air to purge the bypass with a multiplicity of air bursts, preferably five or more. The top section air port is then activated. This is followed sequentially with activation of the diverter plate 1465. This valve closes prior to activation of the spray nozzle assembly 1702 that washes the screen for one to ten seconds, preferably about six seconds. The blower 1760 should be deactivated during the fluid spray cycles and is then reactivated when the spray nozzle pump is de-energized thus completing one cleaning cycle. The cycle as herein described is not limited in scope and each component of the cycle can be varied in frequency and/or duration as necessitated to achieve appropriate removal of the residual pellets.

Blower 1760 in FIG. 3 is prone to abrasion, erosion, corrosion, and wear from by-products of the pelletization process as well as from the impact and/or adhesion of pellets on the surface of blower components, not shown, and can optionally be surface treated utilizing conventional nitriding, carbonitriding, sintering, high velocity air and fuel modified thermal treatments, and electrolytic plating. In addition, flame spray, thermal spray, plasma treatment, electroless nickel dispersion treatments, and electrolytic plasma treatments, singly and in combinations thereof can be utilized as is known to those skilled in the art.

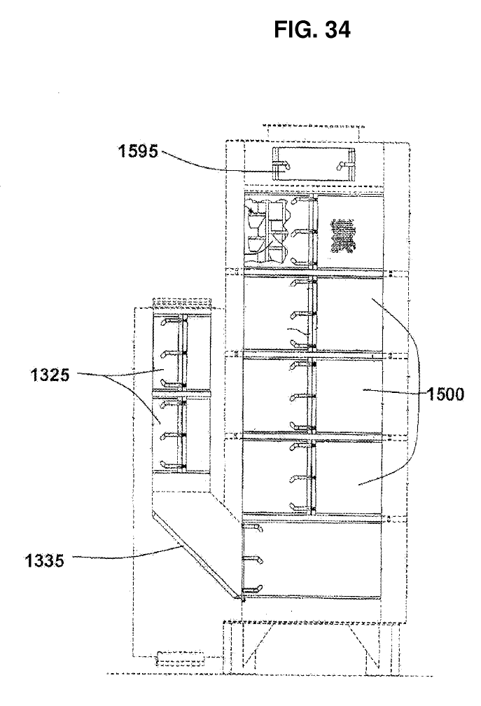

The screens for the process include none, one or more horizontal or vertical dewatering screens 1325, inclined dewatering screen 1335, port screens 1595, and/or one or more cylindrically attachable screens 1500 as illustrated in FIG. 34. The size, composition, and dimensions of the screens should accommodate the pellets being generated and can be perforated, punched, pierced, woven, or of another configuration known to those skilled in the art and can be the same or different in construction, composition, and style. As the pellet size decreases in diameter, preferably the screens will be composed of two or more layers that can be of similar or different composition, design, and size. The screens are fixedly attached by latches, clamps, bolts, and many other mechanisms appropriately understood by those skilled in the art.

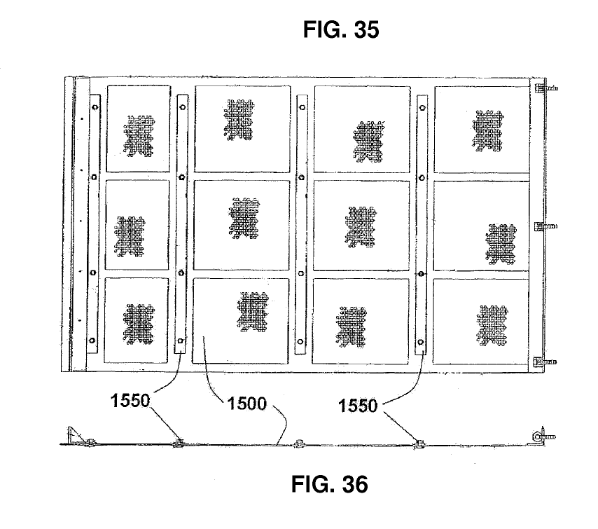

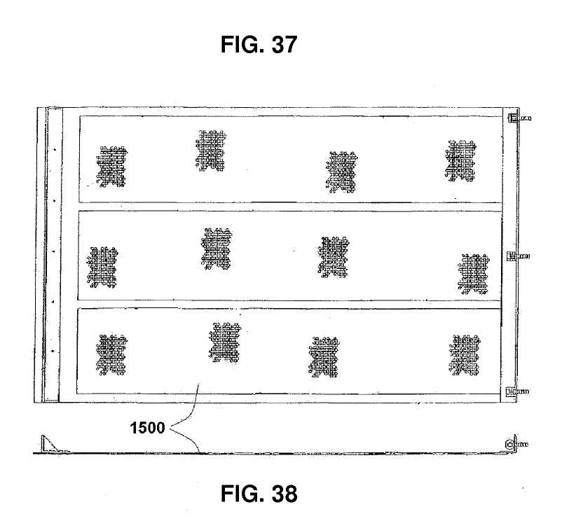

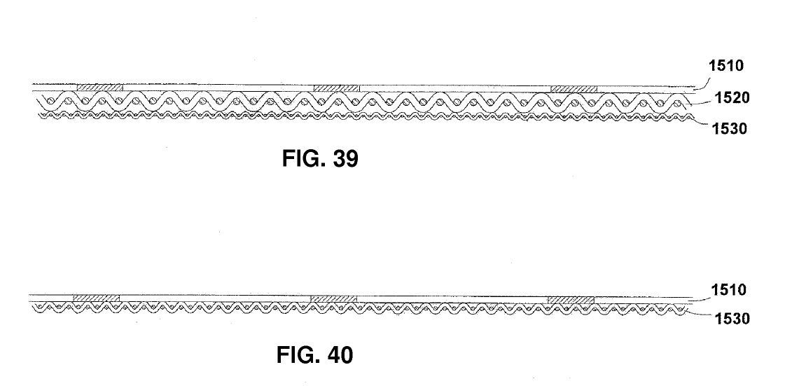

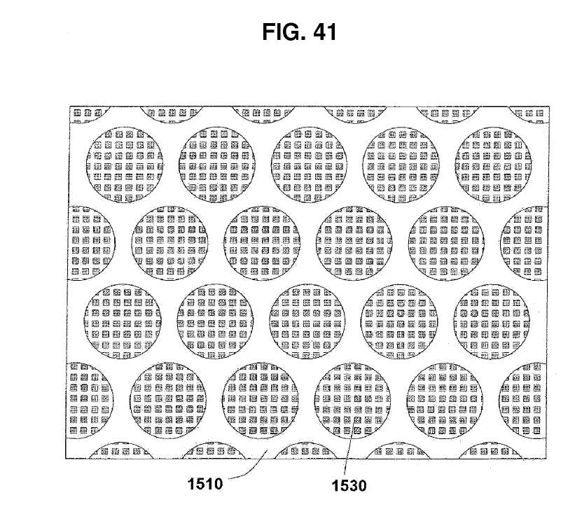

The screens 1500 are preferably of suitably flexible construction as to be circumferentially placed around the dryer 1400 and rotor 1425, and can contain deflector bars 1550 as illustrated in FIG. 35, face view, and FIG. 36, edge view, that are bolted in placed effectively segmentalizing the screen area into approximately equal areas. Alternatively, the screens can by free of deflector bars as seen in the face view of FIG. 37 with an edge view illustrated in FIG. 38. Preferably screens 1500 are compositionally two or more layers functionally incorporating an outer support screen and an inner screen that accomplishes the effective defluidizing of the pellets and smaller micropellets. Additionally, one or more screen layers can be sandwiched between the outer support screen and the inner screen depending upon the particular application. FIG. 39 illustrates an edge view of a three-layer composition and FIG. 40 illustrates a similar edge view of a two-layer composition. FIG. 41 illustrates a surface view of a three-layer screen composition in that the view is from the side of the support layer through which is visualized the finer mesh screen layers.

The outer support screen 1510 can be composed of molded plastic or wire-reinforced plastic and compositionally can be polyethylene, polypropylene, polyester, polyamide or nylon, polyvinyl chloride, polyurethane, or similarly inert material that capably maintains its structural integrity under chemical and physical conditions anticipated in the operation of the centrifugal pellet dryers. Preferably the outer support screen 1510 is a metal plate of suitable thickness to maintain the structural integrity of the overall screen assembly and flexible enough to be contoured, exemplarily cylindrically, to fit tightly and positionally in the appropriate centrifugal pellet dryer. The metal plate is preferably 18 gauge to 24 gauge and most preferably is 20 to 24 gauge in thickness. The metal can compositionally be aluminum, copper, steel, stainless steel, nickel steel alloy, or similarly non-reactive material inert to the components of the defluidizing process. Preferably the metal is stainless steel and most preferably is Grade 304 or Grade 316 stainless steel as necessitated environmentally by the chemical processes undergoing the defluidizing operation.

The metal plate can be pierced, punched, perforated, or slotted to form openings that can be round, oval, square, rectangular, triangular, polygonal, or other dimensionally equivalent structure to provide open areas for separation and subsequent defluidizing. Preferably the openings are round perforations and geometrically staggered to provide the maximum open area while retaining the structural integrity of the outer support screen. The round perforations are preferably at least approximately 0.075 inches (approximately 1.9 mm) in diameter and are positionally staggered to provide an open area of at least approximately 30%. More preferred is an open area geometric orientation such that the effective open area is approximately 40% or more. Most preferred are round perforations having a diameter of at least approximately 0.1875 inches (approximately 4.7 mm) that are positionally staggered to achieve an open area of approximately 50% or more.

Alternatively, the outer support screen can be an assembled structure or screen composed of wires, rods, or bars, stacked angularly or orthogonally, or interwoven, and welded, brazed, resistance welded or otherwise permanently adhered in position. The wires, rods, or bars can be plastic or wire-reinforced plastic compositionally similar to the molded plastic described above or can be metal, similarly and compositionally delineated as above and can be geometrically round, oval, square, rectangular, triangular or wedge-shaped, polygonal or structurally similar. The wires, rods, or bars across the width or warp of the screen can be the same as or different dimensionally as the wires, rods, or bars longitudinally contained as the weft, shute, or otherwise known to those skilled in the art.

Preferably the wires, rods, or bars are a minimum of approximately 0.020 inches (approximately 0.5 mm) in the narrowest dimension, more preferably are at least approximately 0.030 inches (approximately 0.76 mm) in the narrowest dimension, and most preferably are approximately 0.047 inches (approximately 1.2 mm) in the narrowest dimension. Open areas are dimensionally dependent on the proximal placement of adjacent structural elements and are positionally placed so as to maintain a percent open area of at least approximately 30%, more preferably above approximately 40%, and most preferably approximately 50% or greater.

The optional middle screen 1520 or screens and the inner screen 1530 are structurally similar to that described herein for the outer support screen. Dimensionally and compositionally the screens in the respective layers can be similar or different. The percent open area of the respective screens can be similar or different wherein lesser percent open area will reduce the effective open area of the screen and the least percent open area will be the most restrictive and therefore the delimiting percent open area for the screen assembly. The orientation of any screen relative to other layers of the assembly as well as the dimension and structural composition of the screens can be similar or different.

The inner screen 1530 is preferably a woven wire screen that can be in a square, rectangular, plain, Dutch or similar weave wherein the warp and weft wire diameters can be the same or different dimensionally or compositionally. More preferably the inner screen is a plain square or rectangular weave wire screen wherein the warp and weft wires are similar compositionally and dimensionally and the open area is approximately 30% or greater. Even more preferably, the inner layer screen is plain square or rectangular 30 mesh or larger mesh grade 304 or grade 316 stainless steel wherein the warp and weft wires are of a size to allow at least approximately 30% open area and most preferably are approximately 50% open area. Still more preferred is an inner screen of a plain square or rectangular weave of 50 mesh or greater mesh, with a percent open area of approximately 50% or greater. If incorporated, the middle screen 1520 would be of a mesh intermediate between the support screen 1510 and the inner screen 1530, and can be similar or different structurally, geometrically, compositionally, and orientationally. The two-layer screen is a preferred composition as delineated in the disclosure.

Returning to FIGS. 30a and 30b, conventional surface treatments to reduce abrasion, erosion, corrosion, wear, and undesirable adhesion and sticture to many parts of dryer 1400 can be nitrided, carbonitrided, sintered, can undergo high velocity air and fuel modified thermal treatments, and can be electrolytically plated. Exemplary of these dryer components can be included the inner surface of the upper feed chute 1844, the inner surface of the lower feed chute 1846, the inner surface of the base plate assembly 1848, the exterior surface of the pipe shaft protector 1850, the surface of the feed screen 1852 and the surface of the fluid removal screen 1854 (FIG. 31), the surface of the screen assemblies 1856, the surface of the lifter assemblies 1858, the exterior surface of the support ring assemblies 1860, the inner surface of the upper portion of dryer housing 1862, the inner surface of the pellet chutes 1864 and 1868, and the exterior surface of the pellet diverter plate 1866. Components of blower 1760 similarly can be treated as is understood by those skilled in the art. Other surface treatments for improvement of surface properties, enhancement of corrosion and abrasion resistance, and improvement of wear can be used without intending to be limited.

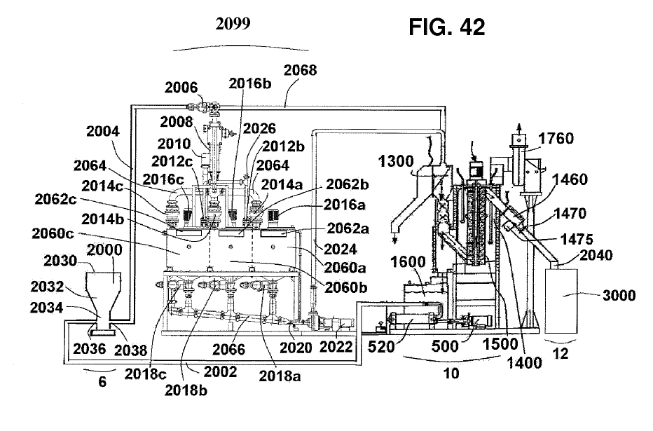

Returning to FIG. 3, pellets discharged from dryer 1400 pass through pellet discharge chute 1460 and optionally can be deflected through exit 1475 as heretofore detailed or can pass through exit 1470 into and through pellet discharge chute extension 2040 separately positioned above and/or preferably attachedly connected to hopper or flow splitter 2000. Hopper or flow splitter 2000, as illustrated in FIG. 42, is metal or plastic square, round, rectangular, or other geometric configuration receiving device, without being limited, for the pellets which is of inlet 2030 diameter larger than the outside diameter of the pellet discharge chute extension 2040 to surroundingly encompass the outflow of pellets. From inlet 2030, the hopper or flow splitter 2000 taperingly decreases 2032 to chamber 2034 that can be geometrically similar or different than is inlet 2030. Hopper or flow splitter 2000 is preferably 18 gauge to 24 gauge metal and most preferably is 20 to 24 gauge in thickness. The metal can compositionally be aluminum, copper, steel, stainless steel, nickel steel alloy, or similarly non-reactive material inert to the components of the defluidizing process. Preferably the metal is stainless steel and most preferably is Grade 304 or Grade 316 stainless steel as necessitated environmentally by the chemical processes undergoing the defluidizing operation.

Additionally, conventional surface treatments to reduce abrasion, erosion, corrosion, wear, and undesirable adhesion and sticture can be applied to the inner surface (not shown) of hopper or flow splitter 2000. The inner surface can be nitrided, carbonitrided, sintered, can undergo high velocity air and fuel modified thermal treatments, and can be electrolytically plated. Materials applied utilizing these processes can include at least one of metals, inorganic salts, inorganic oxides, inorganic carbides, inorganic nitrides, and inorganic carbonitrides wherein the inorganic salts, inorganic oxides, inorganic carbides, inorganic nitrides, and inorganic carbonitrides are preferably metal salts, metal oxides, metal carbides, metal nitrides, and metal carbonitrides, respectively.

As illustrated in FIG. 3 and detailed in FIG. 42, inlet pipe 2002 is attachedly connected to inlet 2036, optionally including a venturi or eductor, to introduce transport fluid to and through chamber 2034 to entrain the pellets into that transport fluid forming a pellet and liquid slurry passes through outlet 2038 into attachedly connected transport pipe 2004. The distal end of transport pipe 2004 is attachedly connected to inlet valve 2006 through which is transported the pellet and liquid slurry into agglomerate catcher 2008 through the tank inlet valve 2014a and into tank 2060a fitted with agitator 2016a. Overflow assembly 2010 allows transport fluid to continue flowing into and through effluent pipe 2066 as eventuated by periodic maintenance thusly preventing shutdown of the continuous process. Alternatively, the transport pipe 2004 may be modified as an accelerated transport pipe as detailed in FIGS. 27 and 28 hereinabove.

Optionally inlet valve 2006 can be attachedly connected to bypass pipe 2068 is illustrated in FIG. 42. This facilitates complete bypass of the pellet conditioning system and connects directly to transport pipe 2024 proximal to the agglomerate catcher 1300. Optional valving (not shown) can be utilized to prevent back-up into pipes not actively in use for the bypass process as is understood by someone skilled in the art.

On start-up, tanks 2060b and 2060c are filled with transport fluid through transport fluid valves 2012b and 2012c, respectively with potential overflow through orifices 2062b and 2062c that attachedly connect to effluent pipe 2066. Initially, the pellet and liquid slurry enters tank 2060a as previously filled tank 2060b begins to drain through drain valve 2018b with transport fluid valve 2012b now closed. Once tank 2060a is filled with the pellet and liquid slurry with agitation and/or after the cycle time is met, inlet valve 2014a closes and inlet valve 2014b opens to fill tank 2060b. Simultaneously, transport fluid valve 2012c is closed and drain valve 2018c opens. The cycle is now continuous and can be fully automated with flow of the pellet and liquid slurry into and ultimately through each of the three tanks 2060a, b, and c, respectively. The inlet valves 2014a, b, and c as well as drain valves 2018a, b, and c can be actuated manually, mechanically, hydraulically, electrically, and many combinations thereof and automation of these processes can be controlled manually by programmable logic control (PLC), or many comparable methods known to those skilled in the art.

On completion of the appropriate residence and/or cycle time for each tank, the appropriate drain valve 2018a, b, or c opens and the pellet and liquid slurry flows into effluent pipe 2066 and is transported assistedly by pump 2022 into and through transport pipe 2024 to a dryer as illustrated in FIG. 42 and heretofore described as dryer 1400 in FIG. 3. The dryer 1400 (FIG. 3) and dryer 1400 (FIG. 42) can be the same or different structurally and/or dimensionally and details and options for the section 10 dryer are detailed in association with dryer 1400 in FIGS. 3, 32 to 41. Pump 520 and heat exchanger 530 as illustrated for FIG. 3 serve comparable or equivalent functions or can differ in sizing including but not limited to head, flow rates, heat loads, and transport agent temperatures as illustrated in FIG. 42 and are fixedly attached to inlet pipe 2002 heretofore described.

Overflow orifices 2062a, b, and c can be attachedly covered by a screen (not shown) of one or more layers and mesh size as dictated by the particle size of the individual process. Screen composition and construction follow that hereinbefore delineated for screen 1500, FIGS. 30 through 41.

Optionally, the entire pellet conditioning system, in FIG. 42 can be elevated above the level of the agglomerate catcher 1300 and dryer 1400 to allow gravity flow into the defluidizing process thusly avoiding the need for pump 2022 as heretofore described.

While FIG. 42 illustrates a preferred three (3) compartment unit design with tanks 2060a, b, and c, at least one (1) tank can allow conditioning to be accomplished in the instant invention. Two (2) or more tanks reduce the effective residence time and improve the operation of the cycle to enhance conditioning. Three (3) or more tanks in a common unit, and more preferably, three (3) or more individual tanks interconnectedly attached to accommodate the appropriate volumes and cycle times as necessitated by the throughput of the individual process are well within the scope of the present invention. As throughput rates and/or residence times for conditioning increase, four (4) or more tanks, stand alone or in unit construction, are still more preferred effectively reducing the individual tank size and enhancing the cycle time as is understood by someone skilled in the art.

Additionally, surface treatments to reduce abrasion, erosion, corrosion, wear, and undesirable adhesion and sticture can be applied to the inner surface (not shown) of tanks 2060a, b, and c, FIG. 42, screens (not shown) over the overflow orifices 2062a, b, and c, and the lumens (not shown) of distribution pipe 2064, effluent pipe 2066, bypass pipe 2068, and transport pipe 2024. The inner surface can be nitrided, carbonitrided, sintered, can undergo high velocity air and fuel modified thermal treatments, and can be electrolytically plated. Materials applied utilizing these processes can include at least one of metals, inorganic salts, inorganic oxides, inorganic carbides, inorganic nitrides, and inorganic carbonitrides. The inorganic salts, inorganic oxides, inorganic carbides, inorganic nitrides, and inorganic carbonitrides are preferably metal salts, metal oxides, metal carbides, metal nitrides, and metal carbonitrides respectively.

Alternatively, hopper or flow splitter 2000 can be fixedly attached at outlet 2038, FIG. 42, to a multiplicity of outlet pipes by common attachment pipe (not shown) through which the throughput flow of the pellet and liquid slurry is divided and distributionally regulated by valves (not shown) as is understood by those skilled in the art, to provide uniform and equivalent flows to a multiplicity of pellet conditioning system (PCS) 2099 assemblies in FIG. 42. The PCS system heretofore described and parallel PCS assemblies optionally can be serially attached to additional PCS systems the numbers of which, both in parallel and/or serially, are dependent on the dimensions of PCS system, pellet content of pellet and liquid slurry, throughput rate, throughput volume, residence time, temperature variance, and degree of conditioning specific to the process for a particular pellet and liquid slurry. Without intending to be bound by theory, PCS systems in series can be the same or different in temperature wherein additional heating potentially can increase the level of conditioning and cooling potentially can decrease the level of tack facilitating the downstream defluidizing and post-processing components of the particular process. The optimization of potential increase in conditioning and potential decrease in tack is determined by the chemical composition and/or formulation of the material being processed.

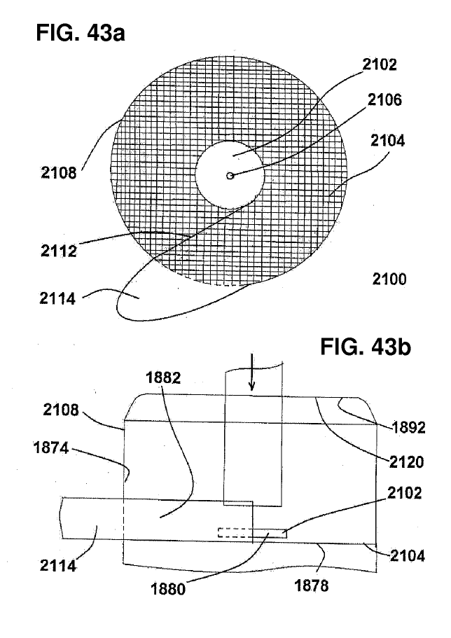

The substantially dried pellets discharged from the dryer 1400 in FIG. 42 exit through pellet discharge chute 1460 to and through exit 1470 and optionally into and through pellet discharge chute extension 2040. These pellets optionally can be packaged, stored, transported or additionally processed. Alternatively, the pellets can be introduced into a coating pan 2102, FIGS. 43a and 43b, which is fixedly attached by bolt 2106 to the sizing screen 2104, preferably centered, in an eccentric vibratory unit 2100. The design and mechanism of operation of an eccentric vibratory unit 2100 are well known to those skilled in the art. The coating pan 2102 preferably is diametrically smaller than the diameter of the sizing screen 2104, and is preferably one-half the diameter of the sizing screen 2104. The circumference of sizing screen 2104 is bounded by unit housing 2108. The coating pan 2104 is comprised of a solid circular base satisfying the heretofore described dimensional constraints with a circumferential wall at the edge of the base of at least approximately one inch (approximately 2.5 centimeters) such that the coating material is contained therein and such that the throughput volume of the pellets introduced from pellet outlet chute 1460 is confined for an appropriate time, at approximately five (5) seconds or less, and more preferably approximately two (2) seconds or less, allowing uniform coating of the pellets expedited by the vibration of the vibratory unit 2100. The screen 2104 composition can be of construction similarly described for screen assembly 1500 of at least one layer previously described herein. The unit is fittedly attached with cover 2120.

The coated pellet ultimately is vibratably shaken from the coating pan 2102 onto sizing screen 2104 and circumnavigates the screen effectively removing excipient coating material that passes through the screen and is expelled from the apparatus through an outlet 2114, FIG. 43b. The coated pellet migrates about the screen until it encounters deflector weir 2112 that redirects the coated pellet through outlet 2114. Deflector weir 2112 is affixedly and tangentially attached to the wall of coating pan 2102 and distally to the unit housing 2108 adjacent to outlet 2114. Preferably the weir 2112 tapers in width from that equivalent to the wall height of the coating pan 2102 to at least two times that at the attachment point adjacent to the unit housing 2108.

Coatings can be applied to pellets to reduce or eliminate tack, to provide supplementary structural integrity to the pellet, to introduce additional chemical and/or physical properties, and to provide color and other esthetic enhancement. Exemplary of coating materials can be, but are not limited to, talc, carbon, graphite, fly ash, wax including microcrystalline, detackifying agents, calcium carbonate, pigments, clay, wollastonite, minerals, inorganic salts, silica, polymeric powders, and organic powders. Preferably, the coating materials are powders.

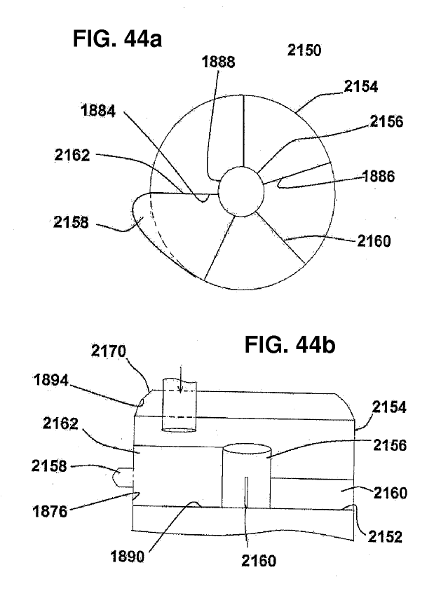

FIGS. 44a and 44b illustrate an alternative eccentric vibratory unit 2150 that can increase residence time allowing additional defluidizing, cooling, and/or preferably conditioning and any combination thereof. The unit 2150 comprises a solid plate 2152 circumferentially enclosed by and fixedly attached to the unit housing 2154. Centrally attached onto the solid plate 2152 is a cylindrical core 2156 to which are attachedly and perpendicularly connected at least one and, preferably, a plurality of weirs. Deflector weir 2162 is fixedly attached to the unit housing 2154 distally from the cylindrical core 2156 and adjacent to outlet 2158. Preferably at least one (1) retainer weir 2160 and more preferably at least two (2) retainer weirs 2160 are similarly attached to the cylindrical core 2156 and the unit housing 2154. Retainer weir or a plurality thereof are lower in height than is the deflector weir 2162 and preferably are one-half the height of the deflector weir 2156. Retainer weirs 2160 are circumferentially placed around the unit 2150 and can be positioned symmetrically, asymmetrically, or both. The unit is fittedly attached with cover 2170.

Pellets are fed into unit 2150 on the side of the deflector weir 2162 remote from outlet 2158. Movement of pellets occurs circumferentially about the unit 2150 until a retainer weir 2160 is encountered, if any, against which pellet volume accumulates until such volume exceeds the height of retainer weir 2160 and pellets fall over to migrate vibrationally therearound to the next retainer weir 2160 or deflector weir 2162 as determined by design of unit 2150. Upon encounter of the pellet and the deflector weir 2156, movement of the pellet is redirected to and through outlet 2158. The design and mechanism of operation of that eccentric vibratory unit 2150 are well known to those skilled in the art. Increasing the number of retainer weirs 2160 increases the volume of pellets allowed to accumulate, thusly increasing the residence time the pellets are retained by the eccentric vibratory unit 2150. Variance of the number and/or height of the retainer weirs 2160 can enhance the effective defluidizing, cooling, and conditioning times for the pellets. On deflection to and through outlet 2158 the pellets can be transported to additional post-processing and/or storage as required.

The present invention anticipates that other designs of eccentric vibratory units, oscillatory units, and their equivalent known to those skilled in the art can be used effectively to achieve comparable results as disclosed herein. Components of the assemblies for the eccentric vibratory units described herein can be metal, plastic or other durable composition and are preferably made of stainless steel, and most preferably are made of 304 stainless steel. The shape of the vibratory units in FIGS. 43a, 43b, 44a, and 44b may be round, oval, square, rectangular or other appropriate geometrical configuration and is not limited.

Referring again to FIGS. 43a, b and 44a, b, conventional surface treatments to reduce abrasion, erosion, corrosion, wear, and undesirable adhesion and sticture to many parts of vibratory units 2100 and 2150 can be nitrided, carbonitrided, sintered, can undergo high velocity air and fuel modified thermal treatments, and can be electrolytically plated. Exemplary of these vibratory unit components can be the inner surface of housings 1874 and 1876, the surface of screen 1878, the surface of coating pan 1880, the surface of deflector weir 1882, the surfaces of deflector weir 1884 and the surfaces of retainer weirs 1886, the outer surface of the cylindrical core 1888, the upper surface of baseplate 1890, and the inner surface of cover assemblies 1892 and 1894. Other surface treatments for improvement of surface properties, enhancement of corrosion and abrasion resistance, improvement of wear, and/or reduction of clumping, agglomeration, and/or sticture can be used without intending to be limited.

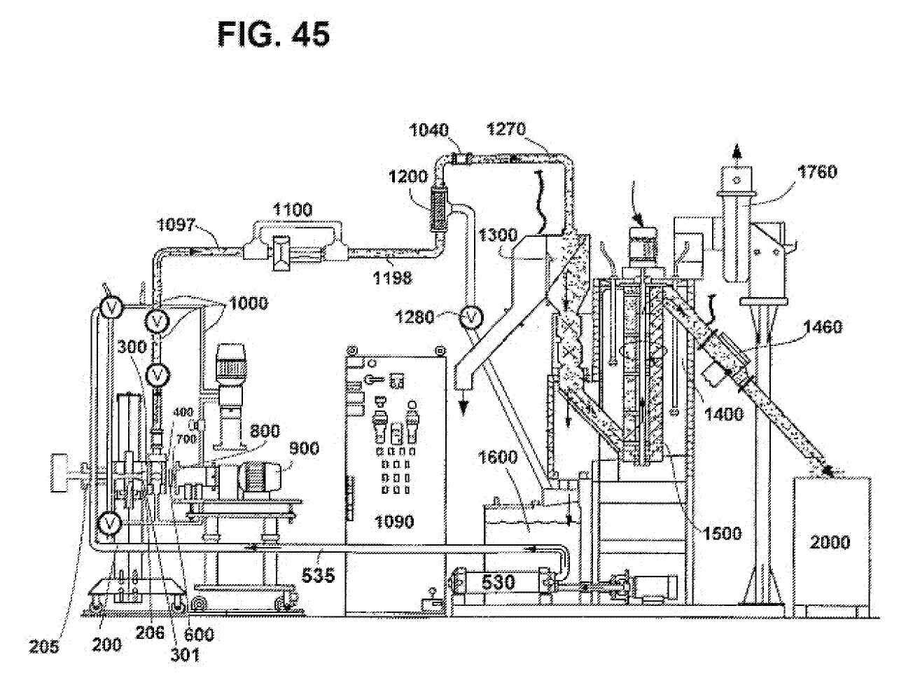

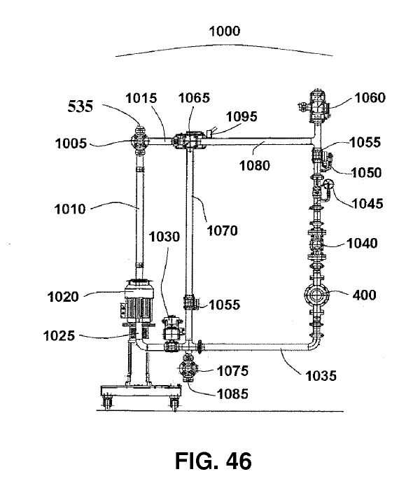

Alternative to the process as described above and to maintain pressure essential to impregnation of the pellets and/or avoidance of loss of volatiles, is the pressurized bypass 1000, as illustrated in FIG. 45 and detailed in FIG. 46. Transport fluids are supplied from inlet pipe 535 into inlet three-way valve 1005. Flow may be directed through pipe 1010 for pressurization or alternatively to pipe 1015.

Pressurization is achieved on flow through pipe 1010 by passing fluid into and through pressure pump 1020 to pipe 1025 and through exhaust valve 1030 with flow blocked by bypass three-way valve 1065. The pressurized fluid passes through pipe 1035 into and through cutting shroud 400 and transports pellets through an appropriately pressure-rated sight glass 1040 and sequentially into and through pressure gauge 1045 and vacuum break check valve 1050 with blocking valve 1055 open allowing the pellet/fluid slurry to pass through outlet 1060 for further processing as described below. To achieve this, drain valve 1075 is closed.

Alternatively, standard flow is achieved analogous to the comparative process detailed above whereby inlet three-way valve 1005 directs flow through pipe 1015 into bypass three-way valve 1065 which directs the standard flow through pipe 1070 into and through pipe 1035 into cutting shroud 400 and transports pellets through an appropriately pressure-rated sight glass 1040 and sequentially into and through pressure gauge 1045 and vacuum break check valve 1050 with blocking valve 1055 open allowing the pellet/fluid slurry to pass through outlet 1060 for further processing as described below. To achieve this, drain valve 1075 is closed and pressure pump 1020 is effectively bypassed.

Draining of the system occurs when inlet three-way valve 1005 directs flow into pipe 1015 and bypass three-way valve directs flow into pipe 1080 with blocking valve 1055 closed and drain valve 1075 open. Flow into the system is effectively drained through outlet 1085 for recycling or disposal.

The pressurization loop and cutting shroud 400 are effectively bypassed by closing blocking valve 1055 and directing flow by inlet three-way valve 1005 into and through pipe 1015 and into bypass three-way valve 1065 which redirects flow through pipe 1080 and through outlet 1060. Control of switching mechanisms and power regulation and distribution are provided through one or more appropriately interfaceable electrical panels 1090, FIGS. 3 and 45, as is well understood by those skilled in the art. Air nozzle 1095 allows bursts of air to be introduced during cleaning cycles as described below which effectively remove pellets which may become lodged in pipe 1080 during operation in which flow proceeds through the cutting shroud 400 and the pellet/fluid slurry produced is propagated through the appropriate apparatus to outlet 1060 as detailed in the foregoing discussion.

Pressurized flow, greater than atmospheric pressure, preferably five bar or greater, and most preferably 10 bar, passes from outlet 1060 into pipe 1097 which must be capable of maintaining the requisite pressure and must be of length and diameter appropriate to transport the pellet/fluid slurry mixture at throughput rates, temperature, and volumes necessary for the process. The length of pipe and composition must be such that maintenance of temperature or cooling as required by the process is achieved.

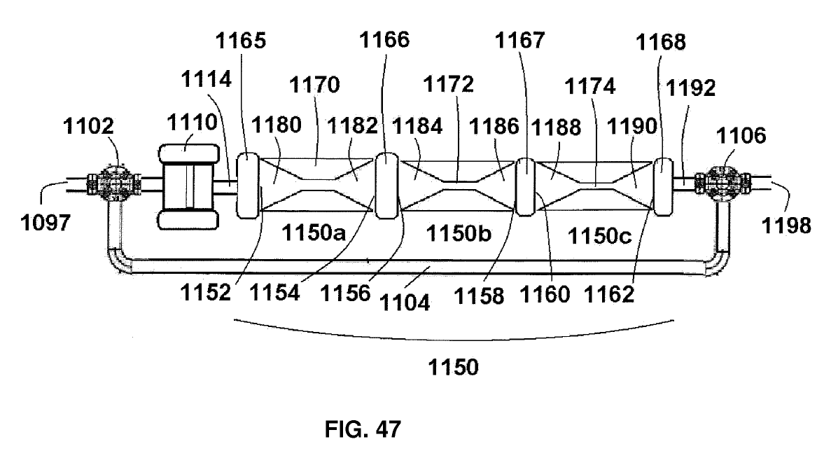

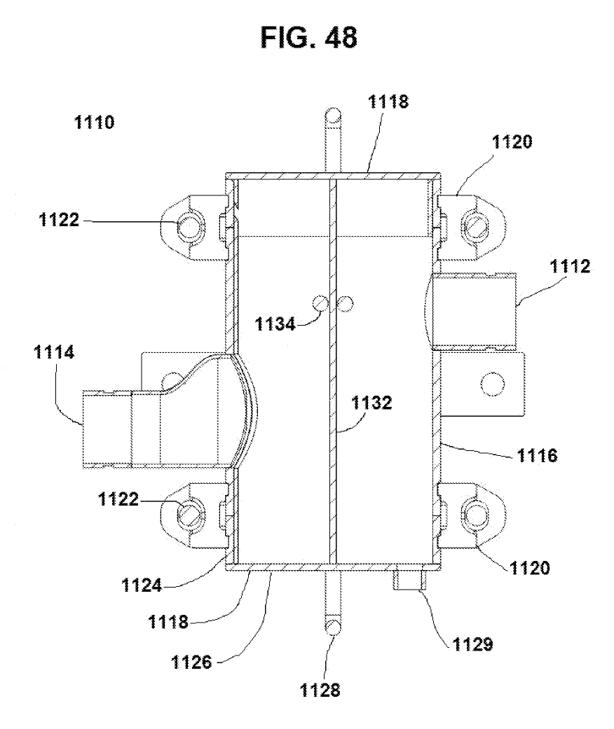

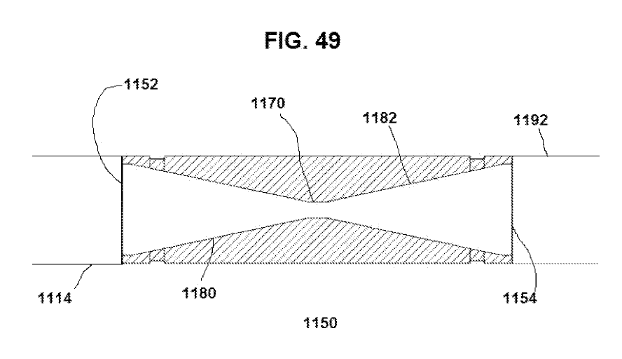

According to the present invention, the pipe 1097 is of sufficient length to require one or more pressure supplement devices 1100 as shown positionally in FIG. 45. Pipe 1097 is connected to optional inlet three-way valve 1102 as illustrated in FIG. 47 which directs the pellet/fluid slurry through bypass line 1104 into outlet three-way valve 1106 and into pipe 1198 effectively serving as a bypass to the pressure supplement device components. Alternatively, the pellet/fluid slurry is directed by inlet three-way valve 1102 into and through basket filter 1110 (see FIG. 48) into one or more conical devices 1150 (illustrated in FIG. 49 and detailed below), preferably two or more in series, in which the flow channel is alternately reduced and enlarged diametrically to expedite the desired level of pressurized flow through the system, a phenomenon described by the well-known Bernoulli effect to those skilled in the art. Flow out of the conical devices passes into and through the outlet three-way valve 1106 and into pipe 1198.

Referring now to FIG. 48, basket filter 1110 has fluid inlet pipe 1112 which is diametrically opposed to fluid outlet pipe 1114 attached to cylindrical housing 1116 which is of a height and diameter appropriate to accommodate the throughput rate and volume required by the process. The housing 1116 has a top and bottom endcap 1118 of comparable diameter which are sealingly attached by clamps 1120 and tightened securely by bolt 1122 or equivalent mechanism. Gaskets and/or other sealing materials may be used to prevent loss of fluid or diminution of pressure as is understood by those skilled in the art.

Endcap 1118 is composed of a cylindrical pipe section 1124 of equivalent diameter to housing 1116 which is sufficiently wide to be attached by clamp 1120. Fixedly attached to cylindrical pipe 1124 is cover plate 1126, of equivalent outer diameter, and handle 1128. To the opposite face of cover plate 1126 are fixedly attached flanges 1130 which are spaced at a distance apart sufficient to allow basket screen 1132 to insert and be held tightly in place and drain 1129.

The basket screen 1132 is equivalent in length to the distance between the top and bottom cover plates 1126 and of equivalent width to the inner diameter of cylindrical housing 1116. The thickness must be sufficient to withstand the flow velocity and pressure of the process and is preferably 18 Gauge or approximately 0.047″. The screen may be woven, punched, perforated, or pierced and is preferably a perforated plate which may be steel, stainless steel, nickel or nickel alloy, plastic or other appropriate durable material and is most preferably a perforated stainless steel plate in which the maximum perforation is of comparable diameter to the smallest diameter of the conical device or devices 1150 as described below. Fixedly attached to cylindrical housing 1116 are two, and preferably four, rollers 1134 which are placed such that the basket screen 1132 fits tightly between them and is free to be removed for cleaning. Rollers 1134 are of sufficient length to traverse the diameter of the cylindrical housing 1116 at the attachment points and are positioned at a distance from the cover plate 1126 at a distance greater than is the length of cylindrical pipe 1124. Rollers preferably are comparably positioned at equivalent distance from both the top and bottom cover plates 1126.

The conical, biconical, or hyperboloid device or devices, and preferably conical device or devices 1150 consist of a cylinder with inlet 1152 diametrically of common dimension as fluid outlet pipe 1114 as shown in FIG. 49. The taper 1180 may begin at the inlet 1152 or alternatively may begin at a distance appropriate to allow appropriate pressure and decreases diametrically to that of the cylindrical constriction 1170. This cylindrical constriction 1170 is of diameter and length sufficient to create an appropriate pressure for the process and connects with taper 1182 which increases diametrically for an appropriate length to outlet 1154 which may be the same or different in diameter than inlet 1152. Where only one conical device 1150 is utilized outlet 1154 is attached to outlet pipe 1192 as in FIG. 47 which is equivalent in diameter to outlet 1154.

Preferably two or more conical devices are used, and most preferably three are used in series as illustrated in FIG. 47, in which the diameters of the cylindrical constrictions 1170, 1172, and 1174 may be of the same or different diameter and/or length as necessitated by process conditions. The length of cylindrical constrictions 1170, 1172, and 1174 may be from zero inches, essentially a point, to any length less than that of the entire length of the conical device 1150. The lengths of each conical device 1150 may be the same or different, and they are separately identified as 1150a, 1150b, and 1150c in FIG. 49 for clarification of illustration. Similarly, the inlets 1152, 1156, and 1160 may be equivalent or different diameters and lengths as can be outlets 1154, 1158, and 1162. Tapers 1180, 1184, and 1188 may be the same or different in length and degree of taper to cylindrical constrictions 1170, 1172, and 1174, respectively. Tapers 1182, 1186, and 1190 increase in diameter from cylindrical constrictions 1170, 1172, and 1174, respectively and increase diametrically to that of outlet 1154, 1158, and 1162, respectively with lengths and degree of taper appropriate to satisfy the process requirements.

Preferably conical devices 1150a, 1150b, and 1150c are identical in overall length in which cylindrical constriction 1170 is diametrically larger than cylindrical constriction 1172 which is larger than cylindrical constriction 1174 whose lengths may vary as necessitated for optimization of pressurization and flow. Inlet 1152 must be comparable to outlet pipe 1114 diametrically. Similarly, outlet 1154 and inlet 1156 are diametrically equivalent as are outlet 1158 and inlet 1160, outlet 1162 and outlet pipe 1192. All conical devices 1150 are clamped in place and preferably are clamped by quick disconnects as illustrated in FIG. 47 for clamps 1165, 1166, 1167, and 1168 which are sized appropriately for the diameters of the respective conical device 1150 or conical devices 1150a, 1150b, and 1150c which may be dissimilar or are preferably equivalent diametrically.

Outlet pipe 1192 connects to outlet three-way valve 1106 where the aforementioned bypass is utilized or directly to pipe 1198 for downstream processing in its absence. Pipe 1198 must be of suitable length and diameter to accommodate the volume flow rate and throughput for the process and to allow cooling of the pellets to achieve a sufficient level of outer shell formation to complete solidification to allow downstream dewatering, defluidizing, and post-processing with minimal or no loss of volatiles and/or without unwanted or premature expansion.

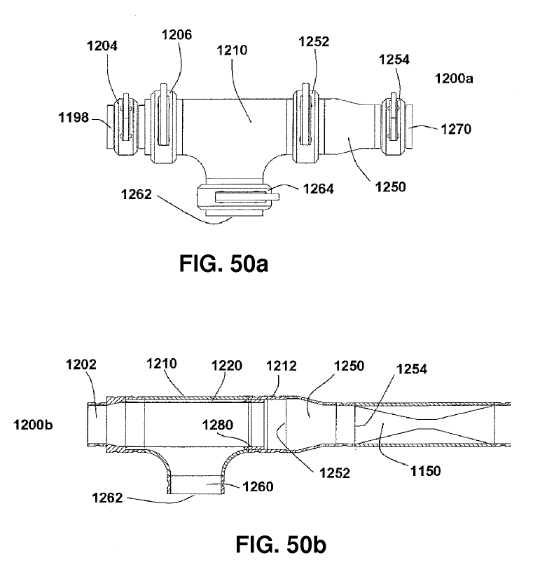

Once the pellet is sufficiently solidified for processing, it is transported via pipe 1198 optionally to and through a pressurized fluid removal device 1200 or directly to and through an agglomerate catcher/dewatering unit 1300 and into the defluidizing unit 1400 as illustrated in FIG. 45. The pressurized fluid removal device 1200 is attachedly connected to pipe 1198 at inlet 1202 as shown in FIG. 50a and b. Inlet 1202 is fittingly attached to housing 1210 which are clamped in position preferably by quick disconnect clamps 1204 and 1206 respectively. The housing 1210 is connected at outlet 1212 to reducing pipe 1250 longitudinally and distally positioned relative to inlet 1202 and clamped as before, preferably with quick disconnect clamp 1252. Dewatering outlet 1260 is orthogonally positioned relative to inlet 1202 and is attachedly connected to dewatering pipe 1262 by clamp 1264, preferably quick disconnects as above.

Within housing 1210, preferably larger in diameter than pipe 1198, is cylindrical screen element 1220 which is of at least comparable inner diameter as are inlet 1202 and/or outlet 1212 and preferably is slightly larger diametrically than are inlet 1202 and/or outlet 1212. Dewatering outlet may be equivalent or different in diameter as compared with inlet 1202 and/or outlet 1212 and is preferably larger in diameter. Inlet 1202 and outlet 1212 may be equivalent or different in inner diameter, and are preferably equivalent allowing the screen element 1220 to remain cylindrical across its length which is equivalent to the distance across the pressurized fluid removal device 1200 between inlet 1202 and outlet 1212. Screen element 1220 is fixedly attached at the inlet 1202 and outlet 1212 as is exemplified in FIG. 50a.

Alternatively, as shown diagrammatically in FIG. 50b, inlet 1202 and/or outlet 1212 may larger in diameter than is pipe 1198 and may be tapered or angularly reduced in diameter sufficient to be equivalent to the diameter of the screen such that a lip 1280 is formed against which the screen member 1220 is tightly and fittingly positioned. The lip 1280 as shown in FIG. 50b is preferably at outlet 1212 and allows the screen to be held in place by the fluid pressure against it. This preferred design allows the screen element to be replaced periodically as necessary.

Cylindrical screen element 1220 may be perforated, woven, pierced, or punched and may be in one or more layers fixedly attached in which the screen openings are sufficiently small to prevent loss of pellets in the dewatering process. Successive layers may be the same or different structurally and compositionally and may be similar or different in terms of screen size opening. The screen may be steel, stainless steel, nickel or nickel alloy, plastic, or any durable composition as is known to someone skilled in the art. Similarly the thickness or gauge of the metal must be sufficient to withstand the flow velocity, vibration, and throughput, and flexible enough to be formed into cylindrical contour without any leakage of pellets under the pressure constraint of the processing.

Attached at outlet 1212 is reducing pipe 1250 which may be the same or different diameter of inlet 1202. More specifically, reducing inlet 1252 must fittingly attach to outlet 1212 and be of comparable diameter for clamping as described above. Reducing outlet 1254 must be comparable in inner diameter to that of inlet 1202 and is preferably smaller in diameter to maintain pressure within the pressurized dewater 1200. Alternatively, outlet 1212 or reducing outlet 1254 may be attached to a similar conical device or series of conical devices 1150 previously described, not shown in FIG. 3 or in FIGS. 50a and/or 50b. Pipe 1270 is attached to reducing outlet 1254 or to the outlet from the conical device or devices 1150.

The pressurized fluid removal device 1200 is designed to accommodate pressurized flow of the pellet/fluid slurry into and through it which has sufficiently cooled to avoid loss of volatiles and unwanted or premature expansion. The flow is maintained at least under comparable pressure by the reducing outlet 1254 and/or under comparable or greater pressure optionally by addition of one or more conical devices 1150. The pressure forces significant reduction of fluid used generically as described herein, to concentrate the pellet/fluid slurry for further downstream processing.

Fluid reduction results in the removal of transport fluid through fluid reduction outlet 1260 into pipe 1262 with the rate of fluid reduction controlled by valve 1280 (FIG. 45). The fluid removed may be recycled to reservoir 1600 or elsewhere for purification or modification or it may be removed from the process or discarded as appropriate. The concentrated pellet/fluid slurry is transported through pipe 1270 to undergo additional fluid removal, defluidizing, and downstream processing as required. FIGS. 3 and 45 diagrammatically illustrate the agglomerate catcher/fluid removal device 1300, the dryer 1400, and ultimately to optional downstream processes and post-processing manipulations 99.

According to the above disclosures, a pellet slurry can be produced by one of two methods. In the first method, returning to FIG. 1, pellets 4a can occur through processes utilizing the non-fluid cutting shroud 500, FIG. 17, as well as by use of the one-piece configuration (FIG. 13) or the two-piece configuration (FIG. 14) of cutting shroud 400 wherein no fluid is utilized wherein the pellets cut fall by gravity in all variants as heretofore described. In this method the pellets can freely fall into a hopper 2000, exemplarily shown in FIGS. 3 and 42, into and through the base of which flows a first transport fluid from inlet pipe 2002 passing out through outlet pipe 2004. This pellet manipulation 5 results in formation of a pellet slurry that is transported via outlet pipe 2004 to a first slurry manipulation 6. Comparable devices for collection and subsequent slurrying of the pellets as are known to those skilled in the art can be utilized herein without intending to be limited.

In the second method, once again referencing FIG. 1, the pellet slurry 4b is formed directly in the pelletization process wherein the first transport fluid enters cutting shroud 400 through inlet pipe 404, FIG. 13, or inlet pipe 454, FIG. 14 and other variants as heretofore disclosed. The transport admixes with the pellets to produce pellet slurry 4b which exits cutting shroud 400 through outlet pipe 406, FIG. 13, or outlet pipe 456, FIG. 14, or equivalent variants supra. The pellet slurry 4b is similarly transported to a first pellet slurry manipulation 6.

The first transport fluid can be of any temperature between the boiling points and freezing points of that fluid, below the flash point for the fluid, and below the melting point of the pellet material. Preferably the temperature is within a range from at least approximately 5° C. below the boiling point to at least approximately 5° C. above the melting point, at least approximately 30° C. below the fluid flash point, and at least approximately 20° C. below the melting point of the pellet material. More preferably, the temperature is within a range from at least approximately 10° C. below the boiling point to at least approximately 10° C. above the melting point, at least approximately 30° C. below its flash point, and at least approximately 30° C. to approximately 100° below the melting point of the pellet material. Additionally, the pellet slurry thusly formed can be purged by an inert gas exemplary of which is nitrogen or argon.

The pellet slurry can be thermally regulated, maintaining temperature, or modified, heated or cooled, in accordance with a first slurry manipulation 6, FIG. 1, while in transit by conventional processes including but not limited to jacketed piping through which can be circulated appropriately thermally regulated heat transfer fluids via heat exchangers, for example. Alternatively, the pellet slurry can be transported to a vessel wherein the agitated slurry can be thermally regulated, maintaining temperature, or modified, heated or cooled, by conventional heat transfer, for example.

Transport of the pellet slurry can be expedited by standard transport processes as exemplified by the standard bypass, FIG. 27. Alternatively, transport can be accelerated by injection of air or other inert gas as illustrated in FIGS. 28 and 29. Transport can also be maintained under pressure as shown in FIGS. 45, 46, 47, 48, 49, and 50a, and b. Details of the processes are herein described supra.

Acceleration of the transport process can reduce cooling of the pellets by loss of heat from the pellet into the transport fluid. Similarly, acceleration of the transport process can reduce warming of the pellets by addition of heat to the pellet from the transport fluid. Injection of the air or other inert gas can effect aspiration of the fluid from the pellet surface thus facilitating separation of the pellet from that fluid in downstream processes subsequently enhancing the defluidizing efficiency of that downstream equipment. The temperature differential between the pellet and the transport fluid is an important consideration in control of these heat transfer, aspiration, and/or separation processes.

Pressurization of the pellet slurry can reduce or eliminate loss of volatile components from the pellet, reduce or prevent premature or unwanted expansion of the pellets, and alternatively can impregnate a portion of the transport fluid into at least the surface of the pellet. As above, the temperature of the pellets as well as that of the transport fluid, and subsequently that of the pellet slurry, strongly influences the effectiveness of controlling volatile loss, expansion, and/or impregnation of the pellets. Similarly, the composition of the pellet as well as that of the transport fluid is strongly influential in the ability of the pellet to release, absorb, and/or adsorb components.

The effective temperature of the pellet is influenced by the temperature of the pellet leaving the melting, mixing, and extrusion process 2, FIG. 1, as well as by the thermal transfer to or from that pellet by the transport fluid, the pellet manipulation 5, the pellet slurry 4b, and/or the first slurry manipulation 6. The temperature can effect conditioning of the pellet as well as lead to intrapellet modification thus altering the chemistry within the pellet, as for example, by extraction, chemical reaction and modification, surface modification including porosity, derivatization, polymerization, and/or decomposition of components within the pellet. The choice of temperature is important to insure that sufficient thermal energy is available to achieve the desired result without leading to undesirable results. For example, a material can require a specific temperature to effect conditioning. This can be achieved by raising as well as lowering the effective temperature of the pellet. At higher temperatures that same material can potentially undergo reaction between components of that pellet and/or with the transport fluid, or worse can degrade or decompose. As obviated herein, use of more than one temperature can also be beneficial. It also important that the length of time or residence at a particular condition be controlled. Manipulations of the pellet and pellet slurry can effect changes that occur over a range of time from less than a second to many hours necessitating a broad scope of equipment requirements as hereinabove described.

In an alternative first pellet slurry manipulation 6, FIG. 1, the pellet slurry from either the pellet manipulation 5 or from the pelletization process leading to pellet slurry 4b can be transported to a fluid removal apparatus. The fluid removal apparatus can include at least one of simple filtration, pressurized filtration, vibratory separation, centrifuges, dryers, centrifugal dryers, self-cleaning centrifugal dryers, and the like and preferably can included fluid removal through an agglomerate catcher and fluid removal device as exemplified by agglomerate catcher 1300 and dryer 1400 illustrated in FIGS. 3, 29, 42, and 45. The pellets from which the first transport fluid has been removed can be of sufficient manipulation without optional slurry manipulations 7 and 8, FIG. 1, as to be intermediate pellets 9 and can undergo intermediate pellet manipulation 10 or alternatively are of satisfactory quality as is to be finished pellet 11. Intermediate pellet manipulations 10 are described hereinbelow.

Alternatively, pellets produced by fluid removal and/or defluidizing as first slurry manipulation 6 can be transferred into hopper 2000, FIG. 3 for example, or equivalent as noted hereinabove to be combined with a second transport fluid as illustrated in FIG. 42 through common hopper 2000. The second transport fluid can be the same or different than the first transport fluid in composition and/or in temperature. The preferences for the second transport fluid follow that of the first transport fluid as disclosed hereinabove. The first transport fluid and the second transport fluid can be at least one of miscible, soluble, dispersible, emulsifiable, immiscible, and insoluble as the second transport fluid can be used to facilitate removal of the excipient first transport fluid as well as can be completely independent of the first transport fluid wherein the fluid removal and/or defluidizing process has completely removed the first transport fluid thus effectively defluidizing the pellets produced.

In accordance with the present invention, the pellet conditioning system 2099 illustrated in FIG. 42 serves not only as a method to achieve slow conditioning as herein disclosed but can also serve as a fluid rinsing system and/or a solvent extraction system. Agitation achieved within the multiplicity of tanks can efficiently dissolve, disperse, and/or emulsify residual first transport fluid into second transport fluid. Alternatively, the residence time and temperature variance achievable within the multiplicity of tanks can be utilized to extract components from the pellets. Of particular value is the extraction of residual water from the contents of the pellets to effect enhanced moisture content. Temperature is of particular importance in its effective swelling of the pellets as well as the influence in shifting the solubility equilibrium to draw the undesirable component from within the pellet into the second transport fluid.

All manipulations described for the first slurry manipulation 6 can be suitably performed in optional second slurry manipulation 7 and/or optional third slurry manipulation 8 such that either intermediate pellet 9 or finished pellet slurry 12 is produced.

The transport fluids utilized singly, multiply, and in combination, for processing as herein disclosed, can include water, aqueous solutions, aqueous dispersions, aqueous emulsions, aqueous acids and bases, organic liquids including alcohols, diols, amides, carbonates, esters, ethers, heterocyclics, ketones, phosphorus and sulfur containing esters, saturated and unsaturated hydrocarbons, halogenated hydrocarbons, oils, mineral oils, vegetable oils, fatty acids and esters, silicone oils, organic solutions, organic dispersions, organic emulsions, organic acids and bases, oligomers, polymers including copolymers, fluoropolymers, polymeric dispersions, polymeric emulsions, reactive materials including monomers and oligomers, reactive polymers, and many combinations thereof. Fluids similarly can include liquids under at least one of ambient, reduced, and elevated pressure and can include air and other inert gases. Fluids can be at least one of a solvent, a selective solvent, and a non-solvent for a material, a formulation, as well as for a component or combination of components of the material being processed.

Similarly, the composition of the first transport fluid can be the same as or different than that of the second and/or third transport fluid as disclose herein. Additives for the transport fluid can include but are not limited to cosolvents, mutual solvents, surfactants, foamers or defoamers, emulsion stabilizers or destabilizers, pellet coating formulations, reactive coating formulations, corrosion inhibitors, bactericides, biocides, scale preventatives, friction-reducing agents, enzymes, gel-breaking components or gelling agents, oxidizers or oxygen scavengers, thermal stabilizers, chelating agents, pH modifiers, rheology modifiers, clay-swell modifiers, and/or viscosity modifiers.

The transport fluids can contain coating formulations that form at least one layer on the surface of the pellets introduced such that the coating can be at least one of compatible with the pellet and ultimately part of the pellet formulation on downstream manipulations, protective of the pellet as a layer that prevents egress from, as in loss of components, or ingress to the pellet, as in uptake of unwanted components such as moisture, for example, and/or reactive such that downstream manipulations lead to a change in chemistry that can modify the pellet surface and/or facilitate interpellet bonding, as in proppants, wherein it is desirable for the pellets to physically be bonded together in avoidance of backflushing out of the formation. The coatings can be composed of at least one of waxes, microcrystalline waxes, silicones and reactive silicones, acrylics, polymeric coatings, ionomers, reactive monomers, reactive oligomers, reactive resins, novolacs and resoles, alkyd resins, phenol-formaldehyde resins, phenol-aldehyde resins, melamine-aldehyde resins, urea-aldehyde resins, epoxy resins, furan resins, furfuryl alcohol-aldehydic resins, and the like without intending to be limited.

The transport fluids can be recovered for re-use by recycling, purification, distillation, vacuum distillation, phase separation, defluidizing, filtration, and many other techniques known to those skilled in the art.

In addition to the heretofore disclosed slurry manipulations, the slurry can be chemically modified by addition of the various components as either the pellet slurry from the pellet manipulation 5 or the pellet slurry 4b progresses to first pellet slurry manipulation 6 and optional second and third pellet slurry manipulations 7 and 8 as illustrated in FIG. 1. As a consequence, pellet slurry 4b or alternatively the pellet slurry formed following pellet slurry manipulations can produce a finished pellet slurry 12.

Continuing with FIG. 1, the pellet 4a or intermediate 9 can be of satisfactory composition to be finished pellet 11. Alternatively, pellet 4a can undergo pellet manipulation 5 and/or intermediate pellet 9 can undergo intermediate pellet manipulation 10 to form finished pellet 11. Fluidic pellet manipulations have been described hereinabove. Alternatively, the pellets 4a and/or intermediate pellets 9 can be cooled, dried, and/or conditioned by being subjected to conventional cooling or heating, such as with vacuum defluidizing, fluidization, rotational defluidizing, and the like as are known to those skilled in the art.

Similarly, pellets 4a and/or intermediate pellets 9 can be coated with solids, powders for example, to reduce tack, improve surface integrity, avoid agglomeration, maintain free-flow of the pellet, and the like. The coating can be at least one of compatible with the pellet and ultimately part of the pellet formulation on downstream manipulations, protective of the pellet as a layer that prevents egress from, as in loss of components, or ingress to the pellet, as in uptake of unwanted components such as moisture, for example, and/or reactive such that downstream manipulations lead to a change in chemistry that can modify the pellet surface and/or facilitate interpellet bonding, as in proppants, wherein it is desirable for the pellets to physically be bonded together in avoidance of backflushing out of the formation. The solid coating material can include but is not limited to waxes, microcrystalline waxes, calcium carbonate, silica, fly ash, talc, inorganic oxides, inorganic carbonates, inorganic sulfates, polymeric powders, reactive powders, and the like.

Post-processing manipulations 99 in FIG. 1 can include packaging, storage, transport, molding, extrusion, chemical modification, and the like as is known to those skilled in the art.

As a preferred embodiment of the present invention, the material that can be pelletized includes non-polymeric and rheologically non-shear sensitive and minimally shear-sensitive organic materials that have a melting point or melting point range above ambient temperature and do not decompose with heating under pressure optionally under an inert gas purge, such as nitrogen or argon, for example. Additionally, these pelletizable materials can include low molecular weight, low melting point, moisture-sensitive, hygroscopic or deliquescent, water-soluble, water-dispersible organics, monomers, oligomers, and polymers, and formulations containing at least one of these materials including microencapsulation within these materials. Reactive materials and blocked reactive materials that do not react, such as by cross-linking, polymerization, and decomposition for example, at the processing conditions or in the transport fluids can also be pelletized in accordance with the instant invention.

Exemplary of the materials that may be pelletized are solid organic antioxidants including alkylated monophenols, alkylated thiomethylphenols, hydroquinones, alkylated hydroquinones, hydroxylated thiodihenyl ethers, alkylidene bisphenols, alkylated phenylenediamines and related aminic antioxidants, and triazine compounds. Similarly, solid ultraviolet absorbers and light stabilizers may also be pelletized exemplarily including hydroxyphenylbenzotriazoles, hydroxybenzophenones, sterically hindered amines including oligomers and polymers, oxanilides, hydroxyphenyltriazines as well as solid phosphate, phosphonate, and phosphonite stabilizers.

Additionally, solid surfactants and antistatic agents may be pelletized including anionics, cationics, non-ionics, zwitterionics, amphiphilics, and amphoterics. Solid flame retardants including halogenated alicyclic hydrocarbons, halogenated aromatic hydrocarbons, halogenated bisphenols including adducts of polyethers, epoxies, and polycarbonates, tetrazole salts, cyanurates and isocyanurates, melamines including derivatives, melamine resins, phosphazenes, and polyphosphazenes, and halogenated phosphoric acid esters and derivatives.

Water swellable clays can be used as fillers and are prone to expansion in the presence of water. As such their use is greatly facilitated by implementation of the extant invention. Examples of these clays include bentonite, montmorillonites, and smectites.

Tackifiers and tacky materials can also be pelletized in accordance with the present invention exemplary of which are aliphatic hydrocarbon resins, aliphatic/aromatic hydrocarbon resins, terpenes and polyterpenes, terpene phenolics, rosins gum rosins and esters, wood rosins and esters, tall oil rosins and esters, abietic derivatives, hydrogenated rosins and esters, amorphous polyalphaolefins, butylene and isobutylene polymers, acrylic acid and ester polymers, methacrylic acid and ester polymers, acrylamido-methylpropanesulfonate polymers, and copolymers thereof.

Biodegradable polymers including polyhydroxyalkanoates, polyglycolides, polylactides, polyethylene glycols, polysaccharides, cellulosics, and starches, polyanhydrides, aliphatic polyesters and polycarbonates, polyorthoesters, polyphosphazenes, polylactones, and polylactams can similarly be pelletized. Polysaccharides in particular can be water soluble and/or water-swellable proving difficult to underwater pelletize conventionally. Exemplary of these can be included exudate gums, seaweed gums, seed gums, hemicelluloses, pectins, natural gums, hydroxyethylcellulose, hydroxypropylcellulose, galactomannan gums, guar gums and derivatized guar gums.

Additionally, fatty acid compounds can be pelletized in accordance with the instant invention. These can include, by way of example, fatty acids, fatty acid salts, fatty esters, monoglycerides, diglycerides, triglycerides, fatty amides including erucamide and stearamide. Solid solvents including dimethyl sulfone, ethylene carbonate and the like can be satisfactorily pelletized.

Waxes and waxlike materials can similarly be pelletized according to the instant invent including, by way of example, paraffinic waxes, microcrystalline waxes, natural waxes, hydrogenated tallow and derivatized animal products, oxidized waxes, montan waxes, carnauba, and the like.

Additionally, encapsulated agricultural and pharmaceutical active ingredients, flavors and fragrances, expanding agents, and the like can be pelletized using methods disclosed in the present invention. Low melting polymers and prepolymers as well as organic materials can suitably be pelletized as well. Shear sensitive polymers, typically pelletized by conventional underwater processes, can be pelletized in accordance with the instant invention as well wherein an improvement in the chemical and/or physical properties including at least one of crystallinity, moisture content, enhancement of extractables reduction, reduction of fines generation, facilitation of chemical impregnation, and enhanced handling of brittle and/or friable materials can be realized. Examples of polymers can include polyolefins, polyesters, polyamides, polycarbonates, polyurethanes, polyethers, polysulfones, polysulfides, polycarbonates, polyaldehydes, polyetheretherketones, fluoropolymers, and many copolymers thereof.

The careful selection of the fluids is an important consideration for the processes. Use of a viscous fluid, such as mineral oil, silicone oil, or low molecular weight polymers, for example, can provide protection to pellets that tend to be brittle or friable. The fluid can also be chosen to closely approximate the specific gravity or density of the pellets such that they are more equably buoyant in the agitation and transport processes, for example. Pelletization in a first transport fluid that can be rinsed by a second transport fluid and optionally by a third transport fluid can facilitate defluidizing and downstream processing. This can be exemplified by pelletizing in mineral oil or corn oil as a first transport fluid then rinsing with isopropyl alcohol, the second transport fluid, with a final rinse in either isopropyl alcohol or hexane. Extractability of components, moisture for example, can be influence by use of a polar solvent in which there is higher affinity, thus higher solubility, of the extractable component. The temperature of the fluid chosen can be regulated to achieve reaction or partial reaction, as for urethane prepolymers, as well as to complete a cooking process for a particular product such as animal food pellets, for example. Use of fluids such as toluene or xylene, for example, that can azeotrope a component, water for example, can facilitate defluidizing of the pellets as well as the fluid for recycling. Use of a fluid below the glass transition temperature can at least reduce, and preferably eliminate, pellet tack. Variation of the pH of the fluid can influence extraction processes and surface properties and is particularly important in encapsulation considerations. In making these selections, flammability of the fluid is of extreme importance. Grounding of the equipment is of paramount importance. Control of vapors, purification, and recycling of the transport is also a significant consideration.

What is claimed is:

1. A method for pelletizing and processing material, comprising:
preparing at least one material into a viscous flowable form, wherein the melt viscosity of the at least one material is not affected by mechanical shear;
pelletizing the at least one material into a plurality of pellets; and
transporting the plurality of pellets utilizing at least one transport fluid through at least one processing step.

2. The method of claim 1, wherein the at least one transport fluid is of a temperature range above its melting point and below its boiling point, is below its flash point, and is below the melting range of the pellets.

3. The method of claim 1, wherein the at least one transport fluid is of a temperature range from at least approximately 5° C. above its melting point to at least approximately 5° C. below its boiling point, is at least approximately 30° C. below its flash point, and is at least approximately 20° C. below the melting range of the pellets.

4. The method of claim 1, wherein the at least one transport fluid is of a temperature range from at least approximately 10° C. above its melting point to at least approximately 10° C. below its boiling point, is at least approximately 30° C. below its flash point, and is at least approximately 30° C. to approximately 100° C. below the melting range of the pellet.

5. The method of claim 1, wherein the material being pelletized is non-polymeric.

6. The method of claim 1, wherein the material being pelletized is water-soluble.

7. The method of claim 1, wherein the material being pelletized is water-dispersible.

8. The method of claim 1, wherein the material being pelletized is water-sensitive.

9. The method of claim 1, wherein the material being pelletized is hygroscopic.

10. The method of claim 1, wherein the material being pelletized melts at least at ambient temperature.

11. The method of claim 1, wherein the material being pelletized has at least surface tack at ambient temperature.

12. The method of claim 1, wherein the material being pelletized is not soluble in the at least one transport fluid.

13. The method of claim 1, wherein the material being pelletized is an organic solid at ambient temperature.

14. The method of claim 13, wherein the organic solid is non-polymeric.

15. The method of claim 13, wherein the organic solid is oligomeric.

16. The method of claim 13, wherein the organic solid is polymeric.

17. The method of claim 1, wherein the material being pelletized is a composite formulation.

18. The method of claim 1, wherein the processing step is at least one of a fluid removal step, a rinsing step, a defluidizing step, a conditioning step, an extraction step, a heating step, a cooling step, a chemical modification step, a coating step, and an impregnation step.

19. The method of claim 1, wherein the processing step is a multiplicity of sequential processing steps including, separately and independently, at least one of a fluid removal step, a rinsing step, a defluidizing step, a conditioning step, an extraction step, a heating step, a cooling step, a chemical modification step, a coating step, and an impregnation step.

20. The method of claim 1, wherein the pelletizing step produces a pellet that is combined with the at least one transport fluid to make a pellet slurry.

21. The method of claim 1, wherein the at least one transport fluid is an aqueous liquid, an organic liquid, a polymeric liquid, or combinations thereof.

22. The method of claim 21, wherein the at least one transport fluid is a dispersion.

23. The method of claim 21, wherein the at least one transport fluid is an emulsion.

24. The method of claim 21, wherein the at least one transport fluid is a solution.

25. The method of claim 21, wherein the at least one transport fluid is a coating formulation.

26. The method of claim 25, wherein the coating formulation comprises at least one reactive component.

27. The method of claim 1, wherein transporting the pellets is accelerated by injection of inert gas.

28. The method of claim 1, wherein transporting the pellets is carried out at atmospheric pressure.

29. The method of claim 1, wherein preparing the at least one material includes mixing, melting, blending, or combinations thereof.

30. The method of claim 1, further comprising outputting a pellet-fluid slurry as a final output.

31. The method of claim 1, further comprising outputting a plurality of pellets as a final output.

32. A method for pelletizing and processing material, comprising:
preparing at least one material into a viscous flowable form, wherein the melt viscosity of the at least one material is not affected by mechanical shear;
pelletizing the at least one material into a plurality of pellets utilizing at least a first transport fluid; and
transporting the plurality of pellets utilizing at least a second transport fluid through at least one processing step.

33. The method of claim 32, wherein the first transport fluid and the second transport fluid are the same.

34. The method of claim 32, wherein the first transport fluid and the second transport fluid are different.

35. A system for pelletizing and processing material with at least one transport fluid, comprising:
at least one preparation component, wherein at least one material is prepared into a viscous flowable form, and wherein the melt viscosity of the at least one material is not affected by mechanical shear;
at least one pelletization component, wherein the at least one material is pelletized into a plurality of pellets; and
at least one processing component, wherein the plurality of pellets are further processed.

36. The system of claim 35, wherein the processing component is at least one of a fluid removal component, a rinsing component, a defluidizing component, a conditioning component, an extraction component, a heating component, a cooling component, a chemical modification component, a coating component, and an impregnation component

37. The system of claim 35, wherein the processing component comprises a plurality of sequential processing components including, separately and independently, at least one of a fluid removal component, a rinsing component, a defluidizing component, a conditioning component, an extraction component, a heating component, a cooling component, a chemical modification component, a coating component, and an impregnation component.

38. The system of claim 35, wherein the preparation component is at least one of a mixing component, a blending component, and a melting component.
